(19) United States
(12) Patent Application Publication
(10) Pub. No.: US 2024/0386385 A1
(43) Pub. Date: Nov. 21, 2024

(54) EVALUATION SYSTEM AND METHOD

(71) Applicant: Murata Manufacturing Co., Ltd., Kyoto-fu (JP)

(72) Inventors: Masaharu ITAYA, Nagaokakyo-shi (JP); Kazuki MATSUI, Nagaokakyo-shi (JP); Yusuke MORI, Nagaokakyo-shi (JP); Yuuto NIWA, Nagaokakyo-shi (JP)

(21) Appl. No.: 18/788,578

(22) Filed: Jul. 30, 2024

Related U.S. Application Data
(63) Continuation of application No. PCT/JP2023/000990, filed on Jan. 16, 2023.

(30) Foreign Application Priority Data
Feb. 4, 2022 (JP) 2022-016307
Jul. 29, 2022 (JP) 2022-121312

(51) Int. Cl. G06Q 10/1053

(52) U.S. Cl. CPC G06Q 10/1053

(57) ABSTRACT

An evaluation system that evaluates a vendor who has applied for a business includes: a first evaluator apparatus that is operated by an evaluator belonging to a first group; and a computing apparatus communicates with the first evaluator apparatus and accesses a database. The first evaluator apparatus receives an input of an evaluation for the vendor and transmits the evaluation which has been received to the computing apparatus. The computing apparatus registers a first evaluation information based on the evaluation received from the first evaluator apparatus in the database for each vendor, and when the computing apparatus has received a browsing request in a first communication established by an identification information which is used to identify a person belonging to the first group, the computing apparatus transmits the first evaluation information to a transmission source which has transmitted the browsing request in the first communication.

### CROSS REFERENCE TO RELATED APPLICATION

This is a continuation of International Application No. PCT/JP2023/000990 filed on Jan. 16, 2023 which claims priority from Japanese Patent Application No. 2022-016307 filed on Feb. 4, 2022 and Japanese Patent Application No. 2022-121312 filed on Jul. 29, 2022. The contents of these applications are incorporated herein by reference in their entireties.

### BACKGROUND ART

The present disclosure relates to an evaluation system and a method for evaluating a vendor who applies for a business.

In the past, crowdsourcing has been leveraged in enterprises and the like. Crowdsourcing is generally the process of recruiting the contributions of an unspecified number of people to obtain a service, idea, or content. In crowdsourcing, an evaluation report is usually prepared by a purchaser of a business for a vendor of the business.

Patent Literature 1 describes that, when a person in charge of evaluation inputs an evaluation report of a skill of a dispatch staff member from an input device after completion of a dispatch period of the dispatch staff member, the evaluation report is transmitted to a dispatch information server.
PTL 1: Japanese Patent Laid-Open No. 2001-350881

### BRIEF SUMMARY

An evaluation report is useful as a determination criterion when a recruiter of a business selects an applicant. Therefore, it is desirable that the evaluation report can be widely shared by a large number of recruiters. However, if the range of sharing the evaluation report is widened without limitation, the evaluator may fail to create an appropriate evaluation report because the evaluator is worried about leakage of the evaluation content to the applicant. In this case, the reliability of the evaluation report is reduced.

The present disclosure provides a solution for the above-described problem, and promotes an evaluator to appropriately evaluate a vendor.

An evaluation system according to a first aspect of the present disclosure evaluates a vendor who has applied for a business, the evaluation system including: a first evaluator apparatus that is operated by one or more evaluators belonging to a first group; and a computing apparatus that is configured to communicate with the first evaluator apparatus and to access to a database, in which the first evaluator apparatus is configured to receive an input of an evaluation for the vendor and to transmit the evaluation which has been received to the computing apparatus, the computing apparatus is configured to register a first evaluation information based on the evaluation received from the first evaluator apparatus in the database for each vendor, and when the computing apparatus has received a browsing request in a first communication established by an identification information which is used to identify a person belonging to the first group, the computing apparatus is configured to transmit the first evaluation information to a transmission source which has transmitted the browsing request in the first communication.

An evaluator apparatus according to a second aspect of the present disclosure is operated by one or more evaluators belonging to a first group, the evaluator apparatus including: an interface that receives an operation of inputting an evaluation for a vendor who has applied for a business; a receiving unit that receives a browsing request; a display; and a processor that transmits the evaluation received by the interface and the browsing request received by the receiving unit to a computing apparatus which is configured to access to a database, in which the processor is configured to display the evaluation by the one or more evaluators belonging to the first group on the display when the browsing request is made.

A method according to a third aspect of the present disclosure evaluates a vendor who has applied for a business, the method including: communicating with a first evaluator apparatus operated by one or more evaluators belonging to a first group; receiving an evaluation for the vendor from the first evaluator apparatus; registering a first evaluation information based on the evaluation received from the first evaluator apparatus in a database; and transmitting the first evaluation information to a transmission source that has transmitted a browsing request in a first communication when the browsing request has been received in the first communication established by an identification information which is used to identify a person belonging to the first group.

According to the present disclosure, it is possible to promote an evaluator to appropriately evaluate a vendor.

### BRIEF DESCRIPTION OF DRAWINGS

FIG. 1 is a block diagram showing an outline of a matching system.

FIG. 2 is a block diagram showing a configuration of a sharing server, a recruiter apparatus, and an applicant apparatus.

FIG. 3 is a diagram showing an example of an enterprise database.

FIG. 4 is a diagram showing an example of a member database.

FIG. 5 is a diagram showing an example of a community database.

FIG. 6 is a diagram showing an example of a recruitment case database.

FIG. 7 is a diagram showing an example of a sideline database.

FIG. 8 is a diagram showing an example of an evaluation input database.

FIG. 9 is a diagram showing an example of an evaluation summary database.

FIG. 10 is a diagram illustrating functions of the sharing server, the recruiter apparatus, and the applicant apparatus.

FIG. 11 is a diagram illustrating functions of the sharing server, the recruiter apparatus, and the applicant apparatus.

FIG. 12 is a diagram illustrating functions of the sharing server, the recruiter apparatus, and the applicant apparatus.

FIG. 13 is a diagram illustrating a procedure of registering a recruitment case in the recruitment case database.

FIG. 14 is a diagram illustrating a procedure of searching for a recruitment case from a database.

FIG. 15 is a diagram illustrating a procedure of registering a schedule and an achievement of a sideline in a database.

FIG. 16 is a diagram illustrating a procedure of registering an evaluation of an applicant in a database.

FIG. 17 is a diagram illustrating a procedure of displaying an evaluation of an applicant and a search result of a member on a display.

FIG. 18 is a diagram illustrating a browsable range of the evaluation summary database.

FIG. 19 is a diagram showing an example in which a disclosure range is set in accordance with a disclosure level.

FIG. 20 is a diagram showing a screen displayed on an applicant apparatus of a manager when the manager (a superior of an applicant) checks a subordinate's sideline status.

FIG. 21 is a diagram illustrating functions of a sharing server, a recruiter apparatus, and an applicant apparatus according to Modification 1.

FIG. 22 is a diagram showing an example of a member database according to Modification 1.

FIG. 23 is a flowchart showing a processing procedure of a reverse offer member search process according to Modification 1.

FIG. 24 is a block diagram showing a configuration of a sharing server, a recruiter apparatus, and an applicant apparatus according to Modification 2.

FIG. 25 is a diagram showing an example of a member group database according to Modification 2.

FIG. 26 is a diagram showing an example of a recruitment case database according to Modification 2.

FIG. 27 is a diagram for illustrating functions of the sharing server, the recruiter apparatus, and the applicant apparatus according to Modification 2.

FIG. 28 is a diagram for illustrating a procedure of registering a recruitment case in the recruitment case database according to Modification 2.

### DETAILED DESCRIPTION

Hereinafter, embodiments of the present disclosure will be described in detail with reference to the drawings. Note that the same or corresponding parts in the drawings are denoted by the same reference signs, and description thereof will not be repeated.

### [Background of Proposing Matching System 1]

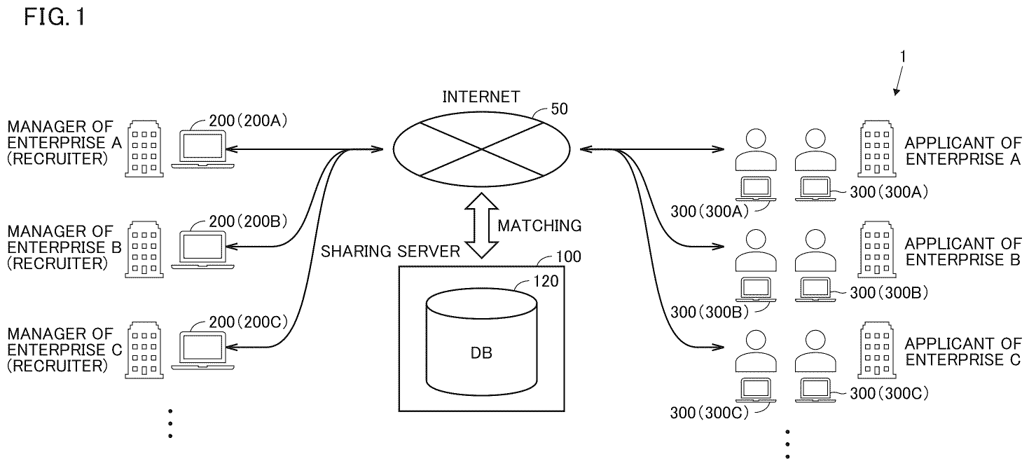

FIG. 1 is a block diagram showing an overview of a matching system 1 according to the present embodiment. First, a background of proposing matching system 1 according to the present embodiment will be described.

Matching system 1 is leveraged for, for example, crowdsourcing among enterprises. Crowdsourcing is generally the process of recruiting the contributions of an unspecified number of people to obtain a service, idea, or content.

Many enterprises are promoting sideline to effectively leverage human resources. By utilizing crowdsourcing among enterprises, the capabilities of the employees of the enterprises can be leveraged.

However, when a general crowdsourcing method is applied among enterprises as it is, the following problem may occur.

### [Possibility of Confidential Information Leakage]

In a general crowdsourcing method, a relation between an enterprise on a purchaser side and an enterprise on a vendor side is not considered, and thus adopting crowdsourcing involves enterprise risk and individual risk. For example, confidential information may be leaked to an enterprise in a rival relation through a sideline of an employee. A manager cannot check that an employee does not accept an order for a case of a competitor as a sideline in a conventional crowdsourcing method.

### [Possibility of Overwork]

When an enterprise allows an employee to do a sideline, the employee's working hours may be excessively long. It is conceivable that in order to eliminate the risk of overwork, an enterprise determines the upper limit of overtime hours including main business hours and sideline hours. However, as long as the employee can freely accept an order for a sideline, it is difficult for the enterprise to manage the sideline hours of the employee. As a result, the employee may be overworked.

[Possibility that Outcome of Sideline is not Duly Evaluated]

Conventionally, there is a crowdsourcing system that requests a purchaser to evaluate a vendor. When the appropriate evaluation made by the purchaser is shared by the crowdsourcing system, the person who recruits a vendor for a business can select a person with high capability from among many persons who desire to accept an order for the business with reference to the evaluation.

However, a purchaser of a certain enterprise may input a higher evaluation than the original evaluation to the system because the purchaser is concerned about a vendor of another enterprise to be evaluated. Further, a purchaser of a certain enterprise may avoid evaluating a vendor of another enterprise low in consideration of the possibility that the relation among enterprises may be deteriorated. Further, the purchaser may not feel a merit in making an evaluation, and may input an evaluation far from the original evaluation to the system. In view of these possibilities, the reliability of evaluations provided by the system may be reduced. In this case, even if the evaluation of vendors is shared, the purchaser of the business cannot leverage the evaluation as reference data when selecting a vendor.

[Specialization regarding Determination of Enterprise as Subject of Matching]

In general, in order to match human resources and business across enterprises, enterprises matching human resources and business need to have a close relation such as a trust relation. Therefore, for example, it is very difficult to match human resources and business among enterprises having no capital relation. In addition, a large enterprise such as a listed enterprise is likely to compete with other enterprises from the viewpoint of diversification or the like, and cannibalization occurs between the large enterprise and other enterprises. Therefore, there is a special situation in which human resources and business cannot be matched among a large number of enterprises.

According to the present embodiment, matching system 1 described in detail below is proposed for the purpose of solving at least one of the above-described various problems of conventional crowdsourcing.

### [Overall Configuration]

The overview configuration of matching system 1 will be described with reference to FIG. 1. Matching system 1 includes a sharing server 100, recruiter apparatuses 200A, 200B, 200C . . . , and applicant apparatuses 300A, 300B, 300C . . . .

Sharing server 100 provides a matching service for matching orders and order acceptances of business among enterprises to a large number of enterprises. In FIG. 1, an enterprise A, an enterprise B, an enterprise C . . . are shown as examples of enterprises that utilize the matching service. Enterprise A, enterprise B, enterprise C . . . are registered as enterprise members of matching system 1. Among employees of enterprise A, enterprise B, enterprise C . . . , persons who utilize matching system 1 are also individually registered as members of matching system 1.

The business to be mediated in matching system 1 is, for example, a temporary business that is expected to be completed within a predetermined period. Therefore, a person who accepts an order for a business to be mediated in matching system 1 is engaged in each business, with the business in a specific department to which the person belongs in the enterprise as a main business and the business to be mediated in matching system 1 as a sideline. In matching system 1, for example, an applicant of enterprise A can also accept an order for a business of enterprise A. Therefore, in matching system 1, an applicant belonging to a different department Y of enterprise A is allowed to accept an order for a business of a department X of enterprise A.

Hereinafter, the business in which the vendor is recruited in matching system 1 may be referred to as “recruitment business” or “recruitment case”, a person who provides the recruitment case may be referred to as “recruiter”, and a person who applies for the order of the recruitment case may be referred to as “applicant”. Applying for the recruitment business may be referred to as “application for the recruitment business” or “application for the recruitment case”.

The applicant who has received the order for the recruitment case corresponds to the “vendor”, and the recruiter who has ordered the case from the vendor corresponds to the “purchaser”. Hereinafter, “applicant” may include “vendor”, and “recruiter” may include “purchaser”.

A database 120 for the matching service is constructed in sharing server 100. Database 120 may include various databases in which information to provide the matching service is registered. For example, information, etc. on members and recruitment business are registered in database 120. Sharing server 100 is managed and operated by an enterprise different from an enterprise that utilizes the matching service. Any enterprise that utilizes the matching service may manage and operate sharing server 100.

Recruiter apparatus 200A is operated by a manager of enterprise A. Recruiter apparatus 200B is operated by a manager of enterprise B. Recruiter apparatus 200C is operated by a manager of enterprise C. Hereinafter, recruiter apparatuses 200A, 200B, 200C . . . may be collectively referred to as “recruiter apparatus 200”.

Applicant apparatus 300A is operated by an applicant of enterprise A. Applicant apparatus 300B is operated by an applicant of enterprise B. Applicant apparatus 300C is operated by an applicant of enterprise C. Hereinafter, applicant apparatuses 300A, 300B, 300C . . . may be collectively referred to as “applicant apparatus 300”. Although two applicants are shown for each enterprise in FIG. 1, the number of applicants is not limited to this. There may be more applicants in each enterprise, or there may be one applicant in an enterprise. Sharing server 100 may accept a person who does not belong to the enterprise such as freelance as an applicant.

The managers of enterprise A, enterprise B, enterprise C . . . are assumed to serve as recruiters according to the present embodiment. Therefore, hereinafter, the manager of each enterprise may be referred to as “recruiter”. The recruiter can also act as an applicant for a business that another recruiter is recruiting. In this case, recruiter apparatus 200 functions as applicant apparatus 300. According to the present embodiment, when a manager of an enterprise acts as a recruiter, the apparatus used by the manager to utilize the matching service is referred to as recruiter apparatus 200.

The number of managers of enterprise A may be one or more. When managers are arranged in enterprise A, recruiter apparatus 200 may be provided to each manager, or one recruiter apparatus 200 may be shared by a plurality of persons. The same applies to enterprise B, enterprise C . . . .

Sharing server 100 and recruiter apparatus 200 are configured to be able to communicate with each other via an internet 50 which is an example of a communication network. Sharing server 100 and applicant apparatus 300 are configured to be able to communicate with each other via internet 50.

Sharing server 100 requests sign-in accompanied by input of a member ID and a password when receiving access from recruiter apparatus 200. Similarly, sharing server 100 requests sign-in accompanied by input of a member ID and a password when receiving access from applicant apparatus 300. Sharing server 100 identifies each of the recruiter and the applicant by the member ID notified at the time of sign-in.

Recruiter apparatus 200 receives various operations of the recruiter. For example, recruiter apparatus 200 receives an operation of inputting a recruitment case (requested business), an operation of inputting an evaluation of a vendor who has finished the business, an operation of searching for a member of the matching service, and the like.

Recruiter apparatus 200 communicates with sharing server 100 in response to each operation on recruiter apparatus 200. Sharing server 100 registers a recruitment case in database 120 in response to an operation of inputting the recruitment case (requested business), registers an evaluation of a target applicant (vendor) in database 120 in response to an operation of inputting the evaluation, and provides information on a member to recruiter apparatus 200 in response to an operation of searching for the member.

Applicant apparatus 300 receives various operations of the applicant. For example, applicant apparatus 300 receives an operation of searching for a recruitment case, an operation of applying for a recruitment case, an operation of inputting a business achievement, and the like.

Applicant apparatus 300 communicates with sharing server 100 in response to each operation on applicant apparatus 300. Sharing server 100 provides an appropriate recruitment case to applicant apparatus 300 in response to an operation of searching for the recruitment case, issues a notification of acceptance or rejection to applicant apparatus 300 in response to an operation of applying for the recruitment case, and registers a business achievement in database 120 in response to an operation of inputting the business achievement.

As described above, matching system 1 includes an evaluation system for evaluating applicants (vendors) of a business and a recruitment system for recruiting vendors of a business.

A recruiter belonging to a certain department of enterprise A can adopt an applicant belonging to another department of enterprise A as a vendor for a recruitment case by utilizing matching system 1. The recruiter belonging to enterprise A can adopt the applicant belonging to enterprise B as the vendor for the recruitment case by utilizing matching system 1.

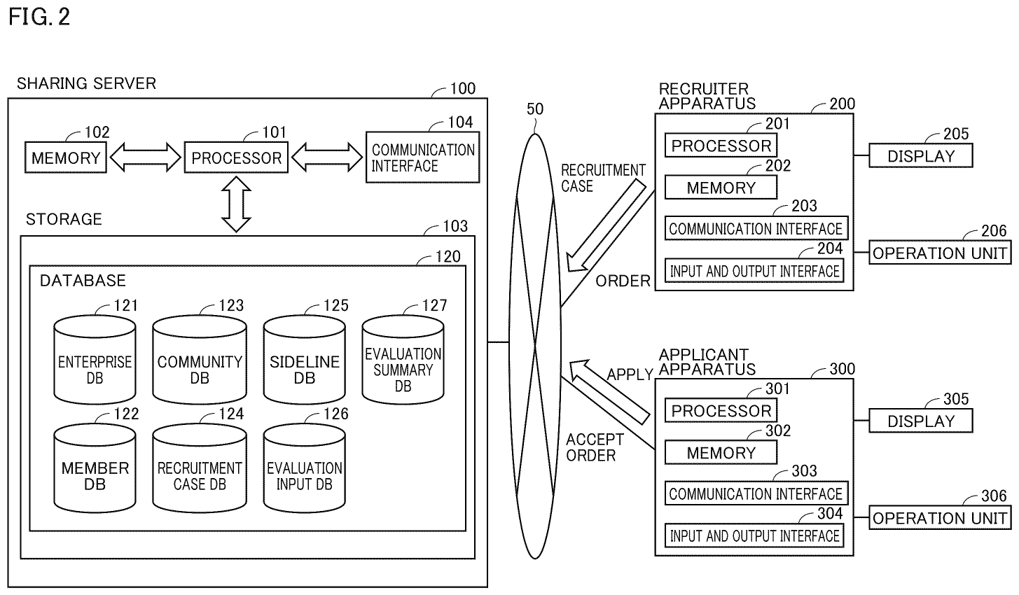

FIG. 2 is a block diagram showing the configuration of sharing server 100, recruiter apparatus 200, and applicant apparatus 300.

### [Configuration of Sharing Server 100]

Sharing server 100 includes a processor 101, a memory 102, a storage 103, and a communication interface 104.

Memory 102 includes a random access memory (RAM), a read only memory (ROM), a flash memory, or any other suitable memory system. Memory 102 stores a program for arithmetic processing of processor 101, temporary data calculated in the arithmetic processing, and the like.

Storage 103 includes a hard disk drive, a solid state drive, and the like. Storage 103 stores database 120. Database 120 includes a plurality of types of databases. The plurality of types of databases includes an enterprise database (enterprise DB) 121, a member database (member DB) 122, a community database (community DB) 123, a recruitment case database (recruitment case DB) 124, a sideline database (sideline DB) 125, an evaluation input database (evaluation input DB) 126, and an evaluation summary database (evaluation summary DB) 127.

A part of the plurality of types of databases may be stored in a storage provided separately from sharing server 100. For example, the databases may be connected to a cloud service which is separate from sharing server 100, and a part of the plurality of types of databases shown in FIG. 2 may be stored on the cloud. In this case, sharing server 100 can access a database by communicating with the cloud via internet 50.

Processor 101 is connected to internet 50 via communication interface 104 in accordance with the program stored in memory 102. Processor 101 is connected to internet 50 and communicates with recruiter apparatus 200 and applicant apparatus 300. Processor 101 accesses database 120 and executes a process of extracting data, a process of registering new data in database 120, a process of updating data registered in database 120, and the like.

### [Configuration of Recruiter Apparatus 200]

Recruiter apparatus 200 includes a processor 201, a memory 202, a communication interface 203, an input and output interface 204, a display 205, and an operation unit 206. Operation unit 206 includes a mouse, a keyboard, and the like.

Memory 202 includes a random access memory (RAM), a read only memory (ROM), a flash memory, or any other suitable memory system. Memory 202 stores a program for arithmetic processing of processor 201, temporary data calculated in the arithmetic processing, and the like.

Processor 201 is connected to internet 50 via communication interface 203 in accordance with the program stored in memory 202. Processor 201 is connected to internet 50 and communicates with sharing server 100. Processor 201 communicates with sharing server 100 and executes a process of transmitting a recruitment case, a process of displaying information on members who are applicants on display 205, a process of ordering a business from a vendor selected from the applicants, a process of transmitting the content of evaluation of the vendor input by the recruiter to sharing server 100, and the like.

Information input by an operation of operation unit 206 is notified to processor 201 via input and output interface 204.

### [Configuration of Applicant Apparatus 300]

Applicant apparatus 300 includes a processor 301, a memory 302, a communication interface 303, an input and output interface 304, a display 305, and an operation unit 306. Operation unit 306 includes a mouse, a keyboard, and the like.

Memory 302 includes a random access memory (RAM), a read only memory (ROM), a flash memory, or any other suitable memory system. Memory 302 stores a program for arithmetic processing of processor 301, temporary data calculated in the arithmetic processing, and the like.

Processor 301 is connected to internet 50 via communication interface 303 in accordance with the program stored in memory 302. Processor 301 is connected to internet 50 and communicates with sharing server 100. Processor 301 communicates with sharing server 100 and executes a process of applying for a recruitment case, a process of displaying a notification of acceptance or rejection of the applied case on display 305, a process of transmitting the achievement of the accepted business to sharing server 100, and the like.

Information input by an operation of operation unit 306 is notified to processor 301 via input and output interface 304.

### [Overview of Database 120]

Hereinafter, an overview of database 120 will be described. Information on enterprises that participate in matching system 1 is registered in enterprise database 121. Information on members who utilize matching system 1 is registered in member database 122. Many members are employees of enterprises that participate in matching system 1.

The members registered in member database 122 can act as recruiters (purchasers) or applicants (vendors) by utilizing matching system 1. The members may include employees belonging to the enterprises registered in enterprise database 121 and individuals (freelances) not belonging to the enterprises.

Community database 123 stores information for identifying enterprises belonging to a community. The community is formed by an agreement among enterprises. Therefore, a plurality of communities can be formed depending on the way of agreement among enterprises. The number of enterprises belonging to one community can be set in various ways. Enterprises having a community relation form a trust relation within a range determined by the way of agreement when forming the community. Information for identifying enterprises belonging to a community is registered for each community in community database 123.

A business (recruitment case) for which a vendor is recruited is registered in recruitment case database 124. An employee of each enterprise can accept an order for a case of another department of the enterprise or a case of another enterprise registered in recruitment case database 124 as a member of matching system 1 while engaging in the main business of the department to which the employee belongs in the enterprise. In this case, the member accepts the order for the case of another department of the enterprise or the case of another enterprise as a sideline.

Data indicating the status of the sideline is registered in sideline database 125 for each member. The data indicating the status of the sideline includes information such as sideline achievement and sideline schedule.

Information on evaluation of applicants (vendors) of a business is registered in evaluation input database 126. A recruiter (purchaser) of a business can evaluate the job of an applicant (vendor) who has finished the business as an evaluator by utilizing matching system 1. The evaluation made by each evaluator is registered in evaluation input database 126.

Evaluation summaries are registered in evaluation summary database 127. Evaluation summaries are registered in evaluation summary database 127 for each member. The recruiter can browse the evaluation summaries. The recruiter can select a member who is considered to be appropriate as a vendor while browsing the evaluation summary of the member who applies for the recruitment case.

### [Enterprise Database 121]

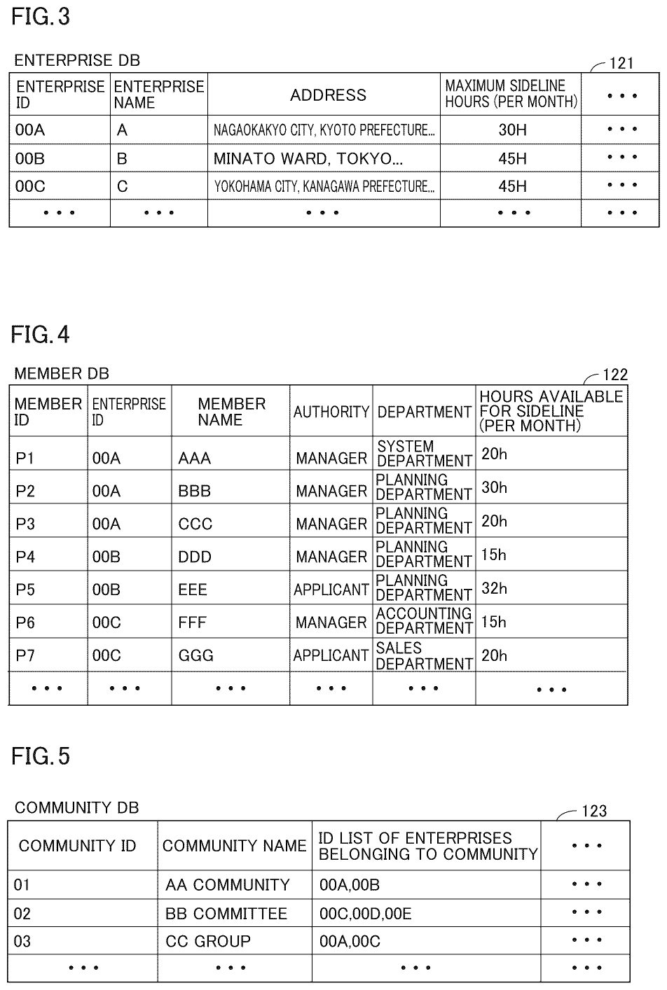

FIG. 3 is a diagram showing an example of enterprise database 121. An enterprise ID for identifying an enterprise, an enterprise name, an enterprise address, and maximum sideline hours are registered for each enterprise in enterprise database 121. The maximum sideline hours are the maximum hours during which the employee is allowed to perform business as a sideline separately from the main business. The maximum sideline hours are determined for each enterprise. For example, the maximum sideline hours can be calculated based on “specified overtime hours—overtime hours in the main work other than the sideline”. The “specified overtime hours” vary depending on the enterprise. Although the maximum sideline hours are shown on a monthly basis in FIG. 3, the maximum hours may be shown on a weekly basis. The unit of the maximum sideline hours may be determined for each enterprise.

According to the present embodiment, a member is allowed to apply for a business that is recruited by various enterprises and departments and accept an order for the business within a range that does not exceed the maximum sideline hours that are set by the enterprise to which the member belongs.

### [Member Database 122]

FIG. 4 is a diagram showing an example of member database 122. Various kinds of information on a member are registered in member database 122. The various kinds of information on the member include a member ID for identifying the member, an ID of an enterprise to which the member belongs, a member name, a member authority, a department to which the member belongs, and hours available for sideline.

The types of the member authority include manager and applicant. The member having the manager authority is given authority to use matching system 1 as a recruiter and an applicant. The member having the applicant authority is given authority to use matching system 1 as an applicant, but is not given authority to use matching system 1 as a recruiter. A department head in the enterprise is given the manager authority to manage the sideline status of the subordinates in the department. The manager having the manager authority is given authority to approve an application of an applicant who is a subordinate. Thus, the manager acts as an approver.

The hours available for sideline are the remaining hours during which the member can engage in a sideline. The hours available for sideline are calculated based on “maximum sideline hours—total sideline hours”. When a target is engaged in a plurality of sidelines, the total sideline hours include the hours already spent on the plurality of sidelines. The total sideline hours include the expected hours of the sideline in addition to the hours already spent on the sideline. The expected hours of the sideline are calculated based on the assumed man-hours registered in recruitment case database 124. FIG. 4 shows the hours available for sideline on a monthly basis. Only the businesses which can be handled with the man-hours within the range of the hours available for sideline are provided as the cases which can be applied for to the applicant who searches for the recruitment business by utilizing matching system 1.

### [Community Database 123]

FIG. 5 is a diagram showing an example of community database 123. Information on a community formed among enterprises is registered in community database 123. The information on the community includes a community ID for identifying the community, a community name, and an ID list of enterprises belonging to the community. Each enterprise can form various communities by making agreements with other enterprises. The enterprise belonging to the community can change the target enterprise belonging to the community by making an agreement with another enterprise.

### [Recruitment Case Database 124]

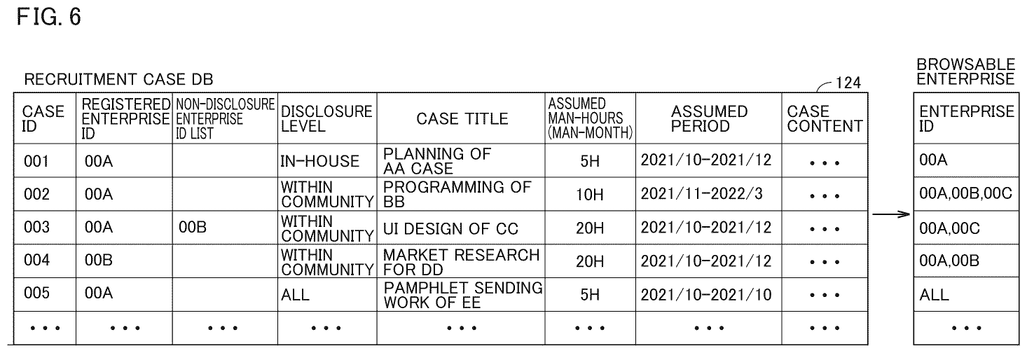

FIG. 6 is a diagram showing an example of recruitment case database 124. Information on the recruitment cases is registered in recruitment case database 124. The information on a recruitment case includes a case ID for identifying the recruitment case, an ID of an enterprise to which the recruiter who has registered the recruitment case belongs, a non-disclosure enterprise ID list, a disclosure level, a case title, assumed man-hours, an assumed period, and a case content.

The IDs of enterprises that are prohibited from disclosing the recruitment cases are registered in the non-disclosure enterprise ID list. As the disclosure level, one of three levels of “in-house”, “within community”, and “all” is set. When the disclosure level is set to “all”, the disclosure targets also include applicants outside the community.

The IDs of enterprises whose recruitment cases can be browsed are shown on the right side of recruitment case database 124 in FIG. 6. For example, in the recruitment case corresponding to the case ID=001, the disclosure level is set to “in-house”. In this case, only members belonging to the enterprise (enterprise ID=00A) that has registered the recruitment case can browse the recruitment case corresponding to the case ID=001.

Hereinafter, the recruitment cases corresponding to each case ID may be referred to as case 001, case 002, case 003 . . . using the case IDs. Similarly, the communities corresponding to each community ID may be referred to as community 01, community 02, community 03 . . . using the community IDs, and the members corresponding to each member ID may be referred to as member P1, member P2, member P3 . . . using the member IDs. In addition, hereinafter, enterprises corresponding to each enterprise ID may be referred to as enterprise A, enterprise B, enterprise C . . . using a part of the enterprise IDs.

In case 002, the disclosure level is set to “within community”. According to community database 123 shown in FIG. 5, enterprises having a community relation with enterprise A that has registered case 002 are enterprise B and enterprise C. Therefore, as shown in FIG. 6, only the members belonging to any of enterprise A, enterprise B, enterprise C can browse case 002.

Case 003 is the same as case 002 in the registered enterprise and the disclosure level of the recruitment case. Here, in case 003, “00B” is registered in the non-disclosure enterprise ID list. Therefore, as shown in FIG. 6, only the members belonging to either enterprise A or enterprise C can browse case 003, and the members belonging to enterprise B are not authorized to browse case 003.

In the case of the recruitment case whose disclosure level is set to “all”, all the members can browse the target recruitment case. Case 005 shown in FIG. 6 corresponds to this. If the IDs of one or a plurality of enterprises are registered in the non-disclosure enterprise ID list of case 005, the members belonging to the enterprises having those enterprise IDs are not given the authority to browse case 005.

The assumed man-hours and the assumed period are used by the applicant and matching system 1 to assume the hours for processing the recruitment case.

### [Sideline Database 125]

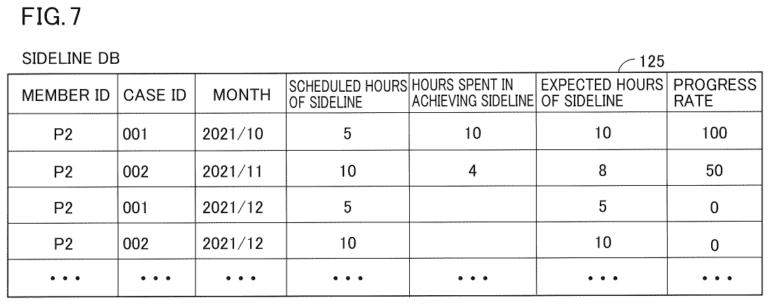

FIG. 7 is a diagram showing an example of sideline database 125. Information indicating a status of a sideline of a member is registered for each sideline case in sideline database 125. The information indicating the status of the sideline includes an ID of the member engaged in the sideline, a case ID, a month (the period of engagement in the sideline), scheduled hours of the sideline, hours spent in achieving the sideline, expected hours of the sideline, and a progress rate.

The scheduled hours of the sideline are hours for the member to process the accepted case. A member who accepts an order for a sideline inputs scheduled hours of the sideline from the member's applicant apparatus 300 every month. The input scheduled hours of the sideline are reflected in sideline database 125. For example, the assumed man-hours of case 001 are set to 5 hours/man-month in recruitment case database 124. This implies a workload of 5 hours per person per month. Usually, the member inputs the scheduled hours of the sideline with the estimated man-hours of the recruitment case as a guide.

The hours spent in achieving the sideline are the hours during which the member has actually engaged in the accepted case. In other words, the hours spent in achieving the sideline are the hours during which the member has already worked as an achievement. The member inputs the hours spent on the business of the case at an arbitrary timing using the member's applicant apparatus 300 every time the member is engaged in the case until the business of the accepted case is completed. The accumulated hours input using applicant apparatus 300 are registered as the hours spent in achieving the sideline every month in sideline database 125.

The expected hours of the sideline are for the business of the target case. In other words, the expected hours of the sideline are hours expected as the member's future working hours. Sharing server 100 automatically sets the expected hours of the sideline in consideration of the scheduled hours of the sideline and the hours spent in achieving the sideline. The member may be allowed to input the expected hours of the sideline at an arbitrary timing using the member's applicant apparatus 300 until the business of the target case is completed. Further, the member may be allowed to modify the automatically set expected hours of the sideline. It is desirable that the expected hours of the sideline are less than or equal to the scheduled hours of the sideline. However, depending on the status of the case, the expected hours of the sideline may be longer than the scheduled hours of the sideline. The member engaged in the case may be allowed to update the expected hours of the sideline at any timing until the business of the case is completed.

The progress rate indicates the degree of progress of the sideline. The progress rate is input based on the determination of the person engaged in the sideline. The progress rate is input between 0 (%) and 100 (%), for example.

For example, when a member initially accepts an order for a certain case, the progress rate is 0%, the hours spent in achieving the sideline is 0 hour, and the scheduled hours of the sideline and the expected hours of the sideline coincide with each other. The expected hours of the sideline changes in conjunction with the member's progress of the business of the case and the input of the hours spent in achieving the sideline and the progress rate.

Sideline database 125 shown in FIG. 7 shows the sideline data from October 2021 to December 2021 of member P2. Referring to sideline database 125 shown in FIG. 7, it is understood that member P2 is engaged in case 001 and case 002 during the period from October 2021 to December 2021.

As the data of October of case 001, the scheduled hours of the sideline=5, the hours spent in achieving the sideline=10, and the expected hours of the sideline=10 are registered in sideline database 125. Thus, it is understood that member P2 has engaged in case 001 in October in excess of the scheduled hours of the sideline.

As the data of November of case 002, the scheduled hours of the sideline=10, the hours spent in achieving the sideline=4, and the expected hours of the sideline=8 are registered in sideline database 125. Thus, it is understood that member P2 has engaged in case 002 in November without exceeding the set expected hours of the sideline. Since the progress rate is 50%, it is understood that member P2 has finished half of the entire business of case 002 in November.

As the data of December of case 001, in sideline database 125, the scheduled hours of the sideline=5 and the expected hours of the sideline=5 are registered, and the hours spent in achieving the sideline are not registered. Similarly, the hours spent in achieving the sideline are not registered as the data of December of case 002. These imply that the input of the hours spent in achieving the sideline by member P2 is awaited.

Sharing server 100 calculates the available capacity of the member to additionally perform the sideline by using the expected hours of the sideline and the hours spent in achieving the sideline of sideline database 125. When the member is engaged in a plurality of sidelines, sharing server 100 calculates a “total expected hours of the sidelines” which is a total of expected hours of the sidelines corresponding to the plurality of sidelines and a “total hours spent in achieving the sidelines” which is a total of hours spent in achieving the sidelines corresponding to the plurality of sidelines. Sharing server 100 calculates the available capacity for sideline by calculating “maximum sideline hours—(total expected hours of the sidelines+total hours spent in achieving the sidelines)”. Here, when “total expected hours of the sidelines+total hours spent in achieving the sidelines” is defined as “total sideline hours”, the available capacity for sideline, that is, “hours available for sideline” is calculated based on “maximum sideline hours−total sideline hours”. For example, in sideline database 125 shown in FIG. 7, the total expected hours of the sidelines, which is the total of the expected hours of the sidelines of December of member P2, are 15 hours (5 hours+10 hours). The total hours spent in achieving the sidelines of December of member P2 are zero. At this time, if the “maximum sideline hours” defined by the enterprise to which member P2 belongs is 30 hours, the available capacity of member P2 for sideline (hours available for sideline) is calculated to be 15 hours (30 hours−15 hours).

Here, an example of a more specific calculation procedure of the expected hours of the sideline will be described. For example, the “expected hours of the sideline” may be calculated based on a calculation formula of “(man-hour progress rate/progress rate)×scheduled hours of the sideline−hours spent in achieving the sideline”. Here, the “man-hour progress rate” is calculated based on “hours spent in achieving the sideline/scheduled hours of the sideline”. As described above, the “progress rate” is a rate input to sideline database 125 based on the determination of the person engaged in the sideline.

For example, when the scheduled hours of the sideline is 10 hours and the hours spent in achieving the sideline is 2 hours, the man-hour progress rate is calculated to be 20%. Here, the progress rate is set to 40%. In this case, the expected hours of the sideline are calculated to be “(20%/40%)×10 hours−2 hours”=3 hours. That is, according to this calculation result, the expected hours of the sideline for the target sideline are 3 hours.

### [Evaluation Input Database 126]

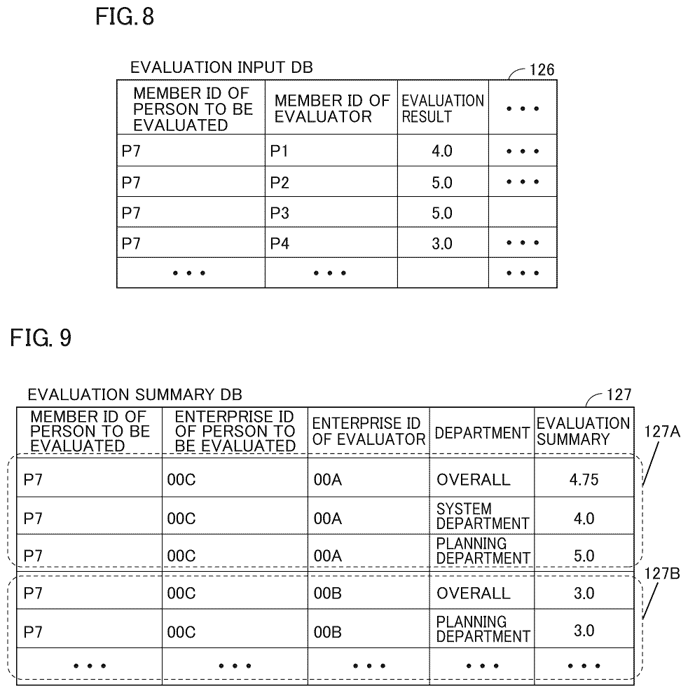

FIG. 8 is a diagram showing an example of evaluation input database 126. Information on evaluation of a person to be evaluated is registered in evaluation input database 126. The information on the evaluation includes a member ID of the person to be evaluated, a member ID of the evaluator, and an evaluation result.

The person to be evaluated is a vendor for the case among applicants to the recruitment case. The evaluator is a recruiter (purchaser) of the case. The evaluation of the person to be evaluated is registered for each evaluator in evaluation input database 126. The evaluation result is represented by a numerical value having 10 as a maximum value and 0 as a minimum value. FIG. 8 shows an example in which member P7 corresponds to the person to be evaluated.

When the business requested to the applicant (vendor) is completed, the recruiter (purchaser) of the business evaluates the person to be evaluated who is the applicant as the evaluator using recruiter apparatus 200. The evaluation result of the evaluator is registered in evaluation input database 126. When a certain recruiter once again requests another business to an applicant to whom a business has been requested, the recruiter evaluates the applicant once again. In this case, the average value of the previous evaluation result and the subsequent evaluation result is registered in evaluation input database 126.

Therefore, the average value of the evaluations of evaluators for the person to be evaluated is reflected in the evaluation result registered in evaluation input database 126. Instead of the average value, a weighted average value, a deviation value, or the like calculated according to the number of evaluations may be adopted. Evaluation results for each case ID may be further registered in evaluation input database 126.

### [Evaluation Summary Database 127]

FIG. 9 is a diagram showing an example of evaluation summary database 127. Information on evaluation by department of a person to be evaluated is registered in evaluation summary database 127. Information on evaluation by organization includes a member ID of the person to be evaluated, an ID of the enterprise to which the person to be evaluated belongs, an ID of the enterprise to which the evaluator belongs, a department to which the evaluator belongs, and an evaluation summary.

FIG. 9 shows an example in which member P7 corresponds to the person to be evaluated. The enterprise ID of the person to be evaluated is “00C”. Therefore, member P7 belongs to enterprise C. In FIG. 9, a data group 127A represents the evaluation of enterprise A for member P7, and a data group 127B represents the evaluation of enterprise B for member P7.

Referring to data group 127A, it is understood that the evaluation of enterprise A is classified into the categories of the evaluation of the entire enterprise, the evaluation of the system department in enterprise A, and the evaluation of the planning department in enterprise A. In the evaluation summary, average values of the classified evaluations corresponding to each of the categories are registered.

For example, as the evaluation summary corresponding to entire enterprise A, an average value of the evaluation results of the members of enterprise A who have evaluated member P7 is registered. As the evaluation summary corresponding to the system department, the average value of the evaluation results of the members belonging to the system department among the members of enterprise A who have evaluated member P7 is registered.

Similarly, the evaluation summary of entire enterprise B and the evaluation summary by department of enterprise B are registered in evaluation summary database 127 for data group 127B representing the evaluation of enterprise B for member P7.

Sharing server 100 identifies the evaluation result of each member using evaluation input database 126 and identifies the affiliation of each member using member database 122. Sharing server 100 updates data of evaluation summary database 127 based on these identification results.

Note that, although only member P7 is shown as the person to be evaluated in FIG. 9, other members P1 to P6, member P8, member P9 . . . are also registered in evaluation summary database 127 as the persons to be evaluated.

### [Functions of Sharing Server, Recruiter Apparatus, and Applicant Apparatus]

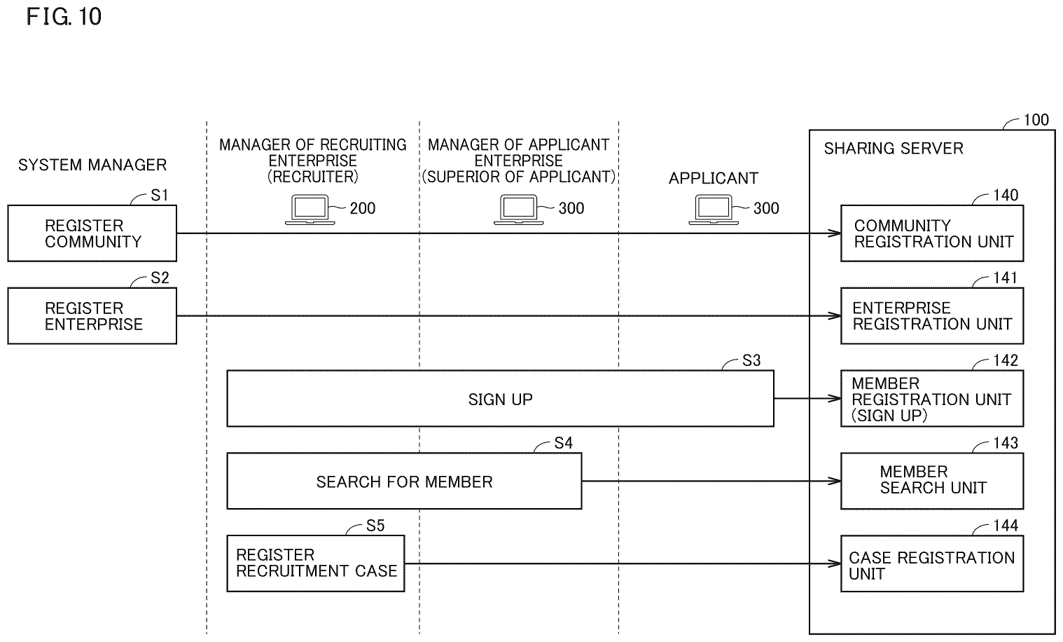

FIGS. 10 to 12 are diagrams for illustrating functions of the sharing server, the recruiter apparatus, and the applicant apparatus.

As shown in FIG. 10, sharing server 100 functionally includes a community registration unit 140, an enterprise registration unit 141, a member registration unit 142, a member search unit 143, and a case registration unit 144. These various functions are implemented by processor 101, memory 102, storage 103, and communication interface 104 included in sharing server 100.

Community registration unit 140 has a function of registering a community in community database 123. A system manager who manages matching system 1 inputs information on a community to sharing server 100 using an operation unit such as a keyboard which is not shown.

The information on the community includes a community name and information on the enterprises belonging to the community. Community registration unit 140 registers the community in community database 123 in accordance with the input of the system manager (step S1). Community registration unit 140 further has a function of updating the information on the community registered in community database 123.

Enterprise registration unit 141 has a function of registering a new enterprise that participates in matching system 1. The system manager inputs information on the enterprise to sharing server 100 using an operation unit such as a keyboard.

The information on the enterprise includes information such as an enterprise name, an address, and maximum sideline hours. Enterprise registration unit 141 registers the enterprise in enterprise database 121 in accordance with the input of the system manager (step S2). Enterprise registration unit 141 further has a function of updating information on an enterprise that has already been registered.

Member registration unit 142 has a function of registering (signing up) a new member who joins matching system 1. Member registration unit 142 issues a member ID and a password in response to a request from a person who belongs to an enterprise that has participated in matching system 1. A person who desires to become a member executes a sign-up process using a personal computer or the like (step S3).

Specifically, a person who desires to become a member inputs information such as a name, an enterprise to which the person belongs, and a department to which the person belongs to a personal computer or the like, and transmits the input information to sharing server 100. Member registration unit 142 registers the input information in member database 122. The new member can sign in to sharing server 100 using the personal computer used for the member registration. In this case, the personal computer functions as recruiter apparatus 200 or applicant apparatus 300.

In FIG. 10, two applicant apparatuses 300 are shown. One of the apparatuses is assumed to be operated by a manager of an applicant enterprise. The other apparatus is assumed to be operated by a person other than manager of the applicant enterprise. The manager of the applicant enterprise is engaged in a managerial position such as department head, and corresponds to the superior of an applicant who is a subordinate. In the present embodiment, the manager of the applicant enterprise serves as an approver who approves the application to the recruitment case by the subordinate.

Member search unit 143 has a function of searching for a member of matching system 1. Recruiter apparatus 200 executes a member search process after receiving a search operation by a recruiter (step S4). Similarly, when applicant apparatus 300 receives a search operation of a manager corresponding to a superior of a certain applicant, applicant apparatus 200 executes a member search process (step S4). Member search unit 143 provides information on members registered in member database 122 to recruiter apparatus 200 and applicant apparatus 300 of the manager.

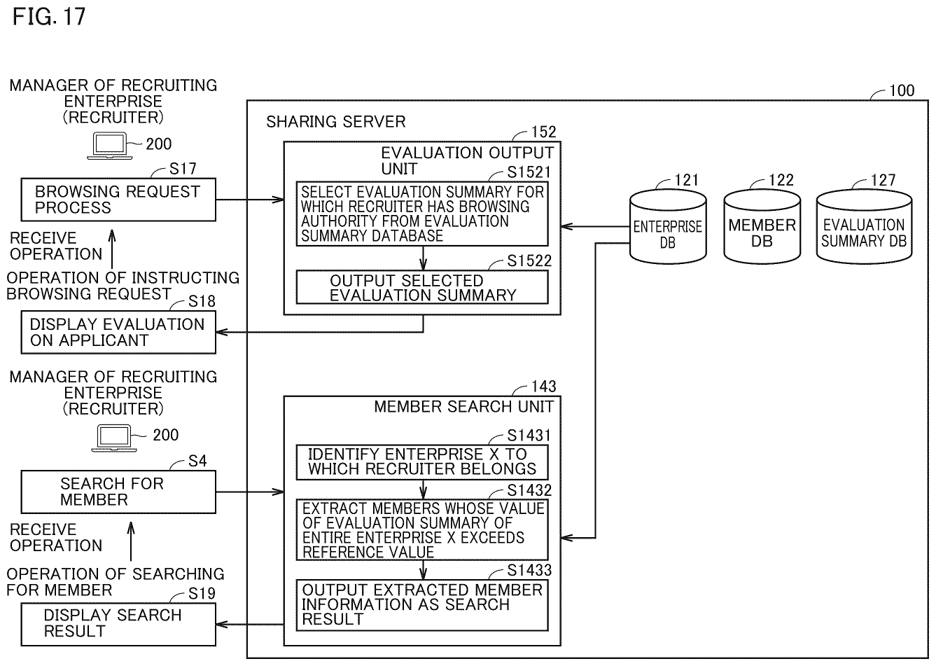

The member search process (step S4) executed by recruiter apparatus 200 and the process of member search unit 143 will be described in detail later with reference to FIG. 17.

Case registration unit 144 has a function of registering a recruitment case in recruitment case database 124. When recruiter apparatus 200 receives an operation of inputting a recruitment case, recruiter apparatus 200 executes a process of registering the recruitment case (step S5). In the process of registering the recruitment case, recruiter apparatus 200 transmits information on the recruitment case to sharing server 100. Case registration unit 144 registers the received information on the recruitment case in recruitment case database 124.

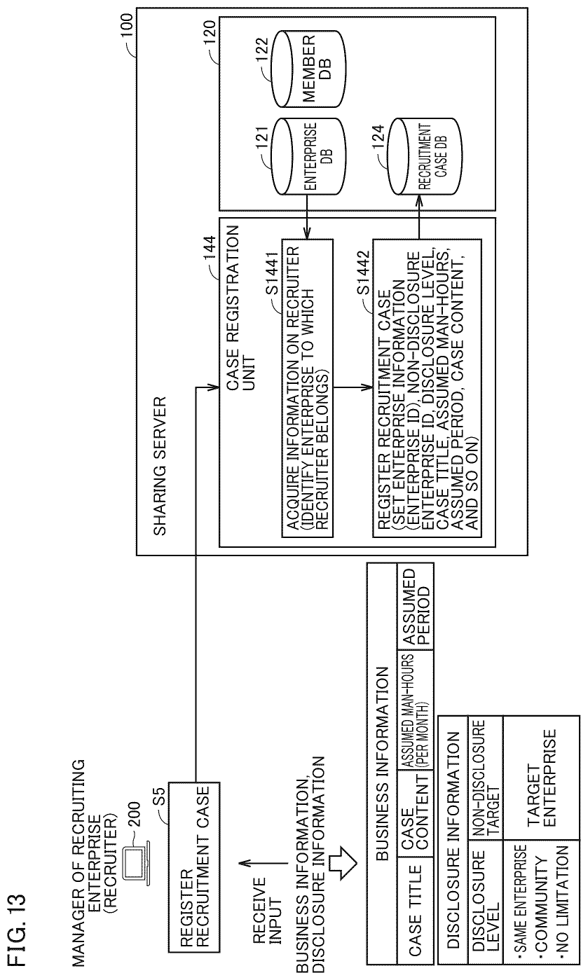

The recruitment case registration process (step S5) executed by recruiter apparatus 200 and the process of case registration unit 144 will be described in detail later with reference to FIG. 13.

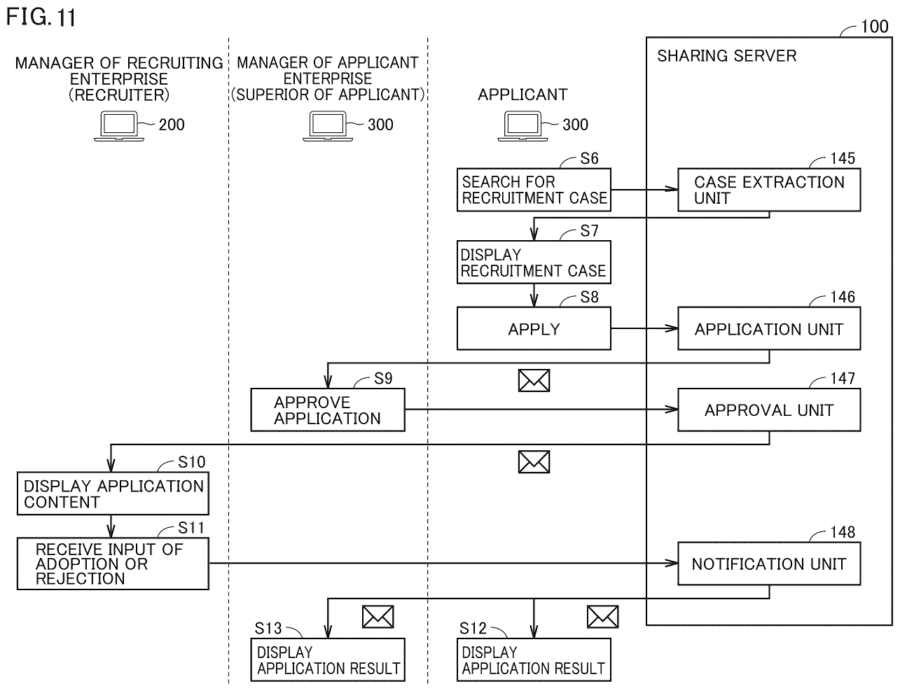

As shown in FIG. 11, sharing server 100 functionally includes a case extraction unit 145, an application unit 146, an approval unit 147, and a notification unit 148. These various functions are implemented by processor 101, memory 102, storage 103, and communication interface 104 included in sharing server 100.

Case extraction unit 145 has a function of extracting a recruitment case that can be browsed by an applicant. Application unit 146 has a function of submitting an application by an applicant to a manager (a superior of the applicant). Approval unit 147 has a function of transmitting the contents of the application for the recruitment case to the recruiter on condition that the approval of the application has been received from the manager (approver). Notification unit 148 has a function of receiving a result of whether or not to adopt an applicant from a recruiter and notifying the applicant and the manager of the result.

Application unit 146, approval unit 147, and notification unit 148 implement notification of requesting approval to the manager, notification of the applicant to the recruiter, and notification of the application result to the applicant by a workflow system.

When applicant apparatus 300 receives an operation of the applicant requesting a search for a recruitment case, applicant apparatus 300 executes a search process for the recruitment case (step S6). In the search process for the recruitment case, applicant apparatus 300 transmits a search request to case extraction unit 145 of sharing server 100.

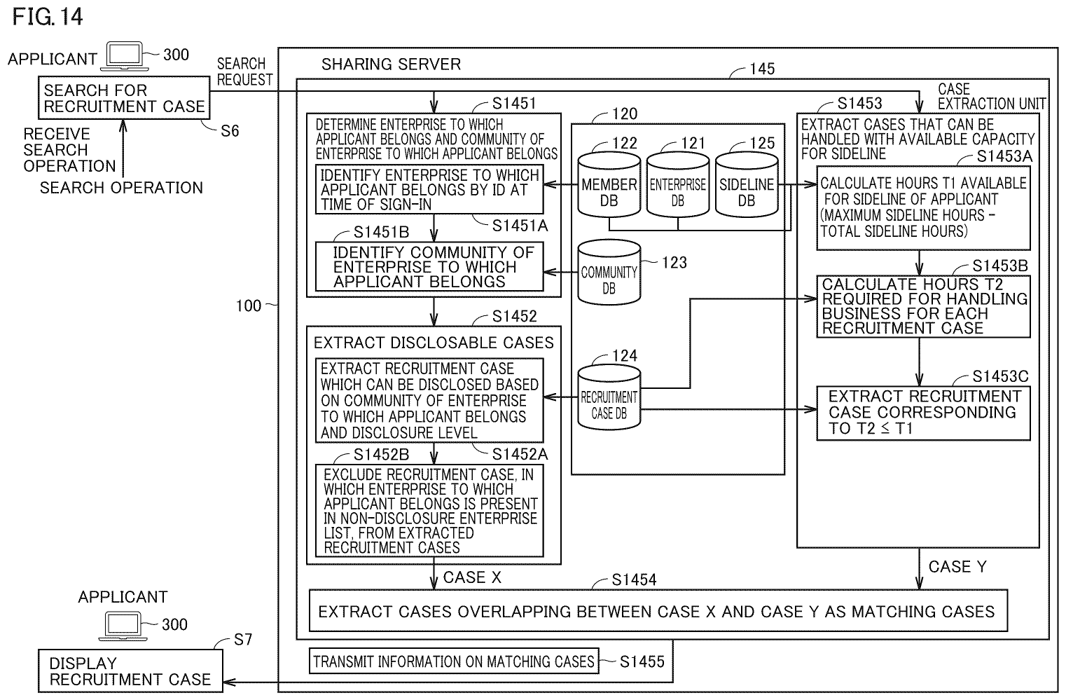

When case extraction unit 145 receives the search request, case extraction unit 145 extracts cases allowed to be browsed by the applicant from the recruitment cases registered in recruitment case database 124, and transmits the extracted cases to applicant apparatus 300. Case extraction unit 145 determines whether a case is allowed to be browsed by the applicant based on a first criterion and a second criterion. The first criterion is a disclosure range set for the recruitment case. The second criterion is the available capacity for sideline of the applicant. The disclosure range is determined by a disclosure information shown in FIG. 13. The available capacity for sideline is calculated as hours available for sideline shown in FIG. 14.

Case extraction unit 145 determines cases satisfying both the first criterion and the second criterion as the cases allowed to be browsed by the applicant. Therefore, case extraction unit 145 extracts the cases allowed to be disclosed to the applicant who has received the search request from the recruitment cases registered in recruitment case database 124. Further, case extraction unit 145 extracts the cases that can be handled within the hours available for sideline of the applicant who has received the search request from the recruitment cases registered in recruitment case database 124. Case extraction unit 145 transmits the cases that are allowed to be browsed by the applicant to applicant apparatus 300.

Case extraction unit 145 may receive an operation of setting a criterion for extracting a case. For example, a function that allows the system manager to select any of a first setting that enables only the first criterion, a second setting that enables only the second criterion, and a third setting that enables both the first criterion and the second criterion may be added to sharing server 100.

Applicant apparatus 300 receives the recruitment cases from case extraction unit 145. Applicant apparatus 300 displays the received recruitment cases on display 305 (step S7).

The recruitment case search process (step S6), the process of displaying the recruitment case (step S7), and the process of case extraction unit 145 will be described in detail later with reference to FIG. 14.

The applicant performs an operation of selecting an application target from the recruitment cases displayed on display 305 on applicant apparatus 300. Applicant apparatus 300 executes the application process in response to the operation of the applicant (step S8). In the application process, applicant apparatus 300 transmits application information indicating the application target case to application unit 146 of sharing server 100. Thus, the order reception desire for the business is transmitted from applicant apparatus 300 to application unit 146.

Application unit 146 transmits the application information received from applicant apparatus 300 to applicant apparatus 300 of the manager (the superior of the applicant). Application unit 146 identifies the member ID of the superior who is the manager of the applicant, for example, based on the relation between the member ID of the applicant and the member ID of the superior registered in member database 122. Application unit 146 transmits application information on the subordinate to applicant apparatus 300 corresponding to the identified member ID of the superior. The manager checks the business applied by the subordinate on the manager's applicant apparatus 300. The manager performs an operation to approve the application on applicant apparatus 300. Applicant apparatus 300 receives the approval operation and executes an application approval process (step S9). In the application approval process, applicant apparatus 300 transmits approval information to approval unit 147 of sharing server 100. Thus, approval information, which is an example of approval notification, is transmitted from applicant apparatus 300 of the manager (approver) to approval unit 147.

Approval unit 147 accepts the application of the applicant on condition that the approval information is received from applicant apparatus 300. Thus, in the present embodiment, the application of the applicant is accepted on condition that the manager to which the applicant belongs approves the application. Therefore, the manager can check in advance the contents of the recruitment business that the subordinate is going to apply for. As a result, it is possible to prevent confidential information from leaking to the outside of the enterprise through the employee's sideline action.

Note that FIG. 11 shows a flow when the manager approves the application. If an operation to reject the application is received in step S9, rejection information is transmitted from applicant apparatus 300 of the manager to approval unit 147. When the rejection information is received, approval unit 147 may notify applicant apparatus 300 of the applicant of the rejection of the application.

Approval unit 147 which has accepted the application of the applicant transmits application information to recruiter apparatus 200. The application information includes information on the applicant and the contents of the application target business. Recruiter apparatus 200 displays the application contents on display 205 (step S10). The recruiter checks the applicant and the applied business based on the display of display 205, and determines whether or not to adopt the applicant.

The recruiter inputs the result of the determination of adoption or rejection to recruiter apparatus 200. Recruiter apparatus 200 receives the input result (step S11). Recruiter apparatus 200 transmits the received result of adoption or rejection to notification unit 148 of sharing server 100.

After receiving the result of adoption or rejection from recruiter apparatus 200, notification unit 148 transmits the application result (the result of adoption or rejection) to applicant apparatus 300 of the applicant and applicant apparatus 300 of the manager.

Applicant apparatus 300 of the applicant and applicant apparatus 300 of the manager display the application result on display 305 (step S12, step S13). The applicant and the manager check the application result by viewing the display of display 305.

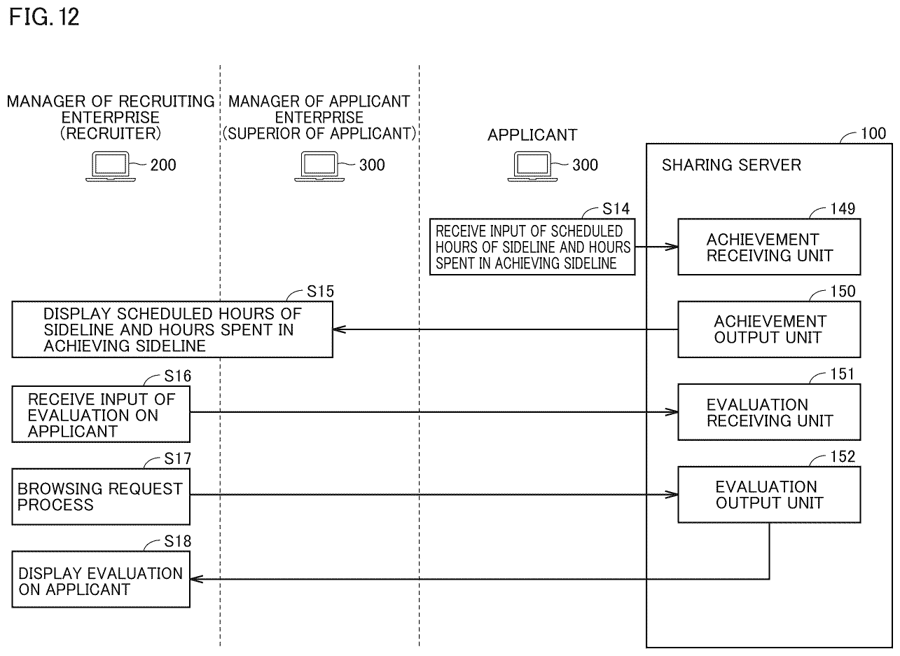

As shown in FIG. 12, sharing server 100 functionally includes an achievement receiving unit 149, an achievement output unit 150, an evaluation receiving unit 151, and an evaluation output unit 152. These various functions are implemented by processor 101, memory 102, storage 103, and communication interface 104 included in sharing server 100.

Achievement receiving unit 149 has a function of receiving the scheduled hours of the sideline and the hours spent in achieving the sideline input by the applicant on applicant apparatus 300. Achievement output unit 150 has a function of outputting information including the scheduled hours of the sideline and the hours spent in achieving the sideline of the applicant to recruiter apparatus 200 or applicant apparatus 300 of the manager.

Evaluation receiving unit 151 has a function of receiving the evaluation of the applicant (vendor) input by the recruiter on recruiter apparatus 200. Evaluation output unit 152 has a function of outputting information indicating the evaluation of the applicant to recruiter apparatus 200.

When the applicant engages in a sideline, the applicant inputs the scheduled hours of the sideline and the hours spent in achieving the sideline to applicant apparatus 300. The applicant usually inputs the scheduled hours of the sideline to applicant apparatus 300 after receiving an order for a new sideline, and inputs the hours spent in achieving the sideline to applicant apparatus 300 at an arbitrary timing while being engaged in the sideline. For example, when an order for a business whose assumed period is a plurality of months is received as a sideline, the applicant inputs the hours spent in achieving the sideline to applicant apparatus 300 every month.

Applicant apparatus 300 receives the input of the scheduled hours of the sideline and the hours spent in achieving the sideline (step S14). Applicant apparatus 300 transmits the received scheduled hours of the sideline and hours spent in achieving the sideline to achievement receiving unit 149 of sharing server 100.

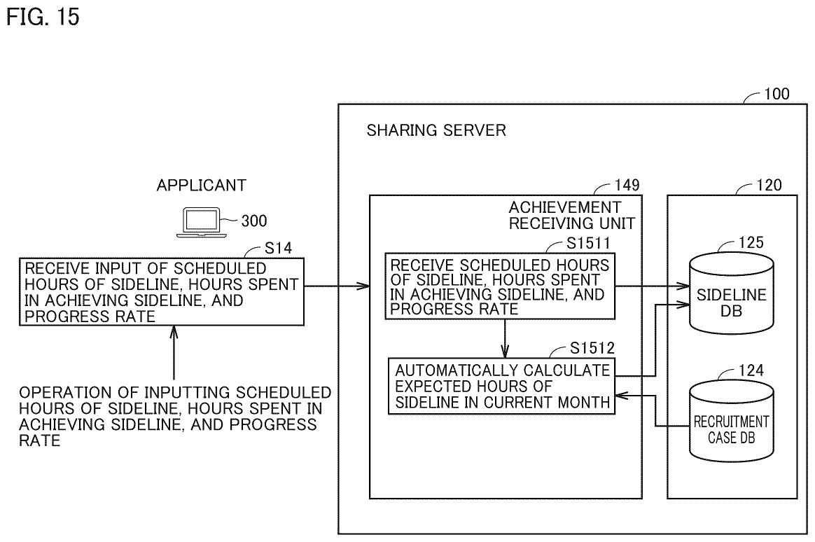

Achievement receiving unit 149 registers the received scheduled hours of the sideline and hours spent in achieving the sideline in sideline database 125. The process of step S14 and the process of achievement receiving unit 149 executed by applicant apparatus 300 will be described later in detail with reference to FIG. 15.

Achievement output unit 150 transmits the scheduled hours of the sideline and the hours spent in achieving the sideline registered in sideline database 125 to recruiter apparatus 200 and applicant apparatus 300 of the manager. Recruiter apparatus 200 displays the received information including the scheduled hours of the sideline and the hours spent in achieving the sideline on display 205, and applicant apparatus 300 of the manager displays the received information including the scheduled hours of the sideline and the hours spent in achieving the sideline on display 305 (step S15). Here, when the information transmitted to recruiter apparatus 200 is compared with the information transmitted to applicant apparatus 300 of the manager, the cases to be transmitted are different.

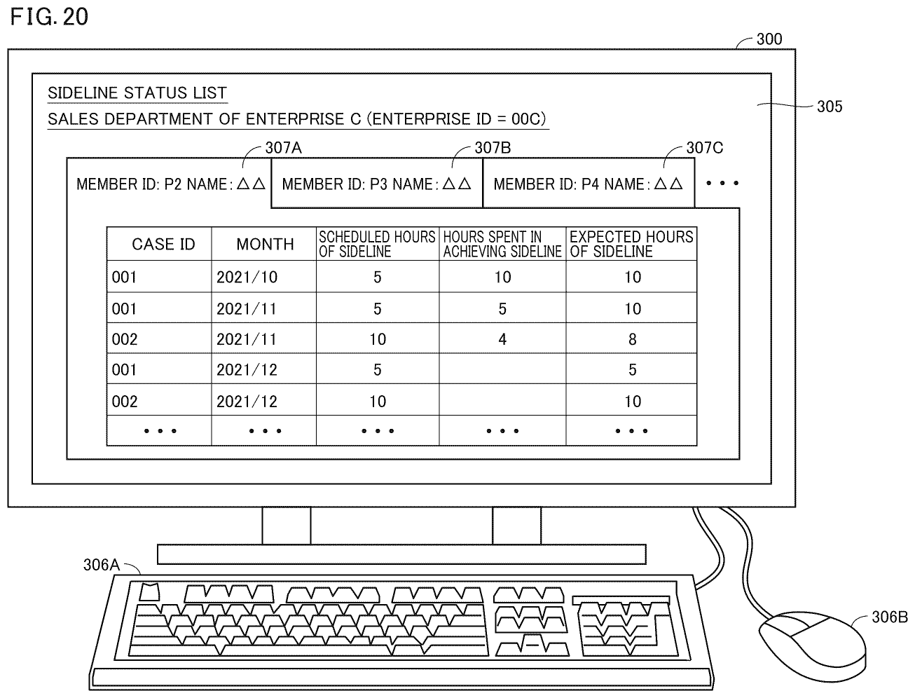

Data corresponding to the case which the subordinate is in charge of among many cases registered in sideline database 125 is transmitted from achievement receiving unit 149 to applicant apparatus 300 of the manager. The manager can check the sideline status of the subordinate by viewing display 305. A screen displayed on applicant apparatus 300 of the manager when the manager checks the sideline status of the subordinate will be described later with reference to FIG. 20.

Data corresponding to the case for which the recruiter is recruiting a vendor among many cases registered in sideline database 125 is transmitted from achievement receiving unit 149 to recruiter apparatus 200. For example, it is assumed that in sideline database 125 shown in FIG. 7, a first recruiter is recruiting for case 001 and a second recruiter is recruiting for case 002 among a plurality of recruiters.

In this case, various data corresponding to case 001 in sideline database 125 are transmitted from achievement receiving unit 149 to recruiter apparatus 200 operated by the first recruiter. Various data corresponding to case 002 in sideline database 125 are transmitted from achievement receiving unit 149 to recruiter apparatus 200 operated by the second recruiter.

The first recruiter and the second recruiter can check the progress status of their own cases by browsing the scheduled hours of the sideline, the hours spent in achieving the sideline, etc. displayed on display 305 of recruiter apparatus 200.

When the sideline is completed, the recruiter inputs the evaluation of the applicant to recruiter apparatus 200. Recruiter apparatus 200 receives the input evaluation (step S16). Therefore, recruiter apparatus 200 functions as an evaluator apparatus operated by the evaluator when receiving the input evaluation.

Recruiter apparatus 200 transmits the received evaluation to evaluation receiving unit 151 of sharing server 100. Evaluation receiving unit 151 updates evaluation input database 126 and evaluation summary database 127 based on the received evaluation.

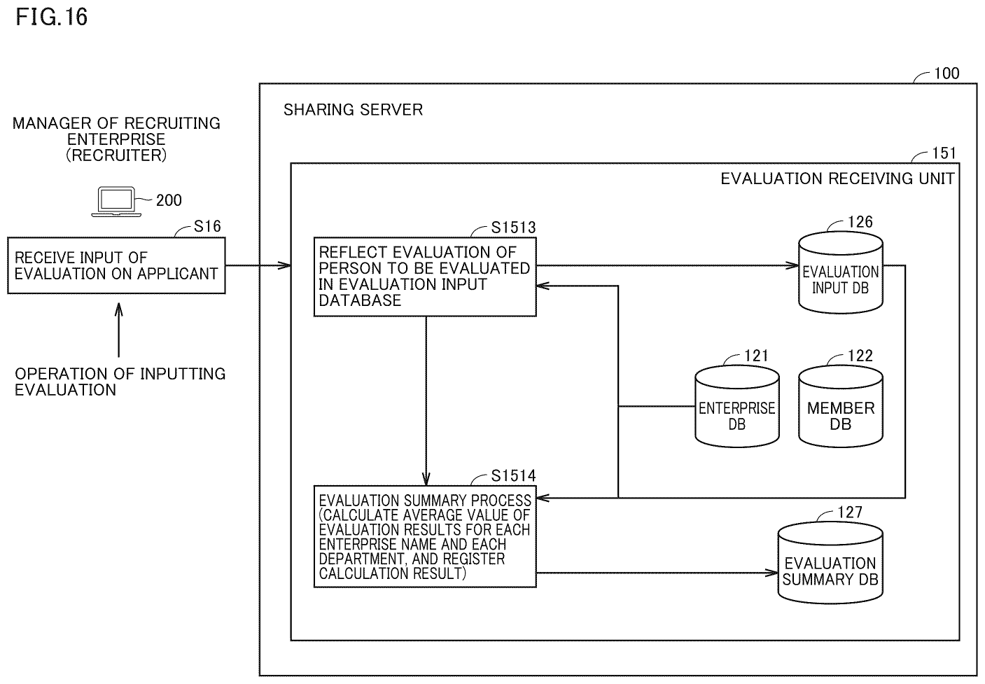

The process of step S16 and the process of evaluation receiving unit 151 executed by recruiter apparatus 200 will be described in detail later with reference to FIG. 16.

When recruiter apparatus 200 receives an operation allowing the recruiter to browse the evaluation of the applicant, recruiter apparatus 200 executes a browsing request process (step S17). In the browsing request process, recruiter apparatus 200 transmits a browsing request to evaluation output unit 152 of sharing server 100. Evaluation output unit 152 transmits the evaluation of the applicant registered in evaluation summary database 127 to recruiter apparatus 200 in response to the browsing request. Recruiter apparatus 200 displays the received evaluation of the applicant on display 205 (step S18).

The processes of step S17 and step S18 and the process of evaluation output unit 152 executed by recruiter apparatus 200 will be described in detail later with reference to FIG. 17.

### [Details of Processes of Case Registration Unit 144 and Recruiter Apparatus 200]

FIG. 13 is a diagram for illustrating a procedure of registering a recruitment case in recruitment case database 124. Step S5 in FIG. 10 and the function of case registration unit 144 will be described in more detail with reference to FIG. 13.

A recruiter who registers a recruitment case first signs in to sharing server 100 using recruiter apparatus 200. Thus, a logical communication path identified by the member ID of the recruiter is established between recruiter apparatus 200 and sharing server 100. Subsequently, the recruiter inputs the business information and disclosure information on the recruitment case to recruiter apparatus 200 using operation unit 206 such as a mouse and a keyboard.

The information input by operation unit 206 is notified to processor 201 via input and output interface 204 of recruiter apparatus 200. Operation unit 206 and input and output interface 204 constitute an interface that receives an operation of inputting the content of a business and an operation of inputting disclosure information for designating a target to which the business is disclosed.

The business information on the recruitment case includes a case title, a case content, assumed man-hours (man-months), and an assumed period. The disclosure information includes a disclosure level. The disclosure information may include an ID of an enterprise to which the disclosure information is not to be disclosed, depending on the selection of the recruiter.

Recruiter apparatus 200 receives the input of the business information and the disclosure information on the recruitment case, and executes the process of registering the recruitment case (step S5). In the process of registering the recruitment case, recruiter apparatus 200 transmits the business information and the disclosure information on the recruitment case to sharing server 100.

Case registration unit 144 of sharing server 100 acquires information on the recruiter (step S1441). Specifically, case registration unit 144 identifies an enterprise to which the recruiter belongs.

Sharing server 100 stores a member ID used for sign-in when a member signs in to sharing server 100 using recruiter apparatus 200 or applicant apparatus 300. When sharing server 100 receives some information from recruiter apparatus 200 or applicant apparatus 300 in the communication established by the member ID, sharing server 100 identifies the member who is the transmission source of the information by the member ID used for the sign-in.

Therefore, when the business information and the disclosure information on the recruitment business are received from recruiter apparatus 200, case registration unit 144 identifies the recruiter who operates recruiter apparatus 200 using the member ID used for the sign-in. Case registration unit 144 identifies the member who is the recruiter and the enterprise to which the recruiter belongs using the identified member ID, member database 122, and enterprise database 121.

Next, case registration unit 144 executes a process of registering the recruitment case in recruitment case database 124 (step S1442). Specifically, after generating a case ID, case registration unit 144 registers enterprise information (enterprise ID), an ID of a non-disclosure enterprise, a disclosure level, a case title, assumed man-hours, an assumed period, a case content, and the like in recruitment case database 124 in association with the generated case ID.

According to the present embodiment, the recruiter can freely control the disclosure range of the recruitment case at the level of “in-house”, “within community”, and “without limitation”. As a result, it is possible to prevent the disclosure of a recruitment case to a specific enterprise that the recruiter does not intend.

According to the present embodiment, a non-disclosure enterprise can be set separately from the disclosure level. Therefore, the recruiter can set the disclosure range by excluding some of the enterprises among the plurality of enterprises having a community relation with the enterprise to which the recruiter belongs. As a result, it is possible to prevent the business related to a specific enterprise in the community from being disclosed to the specific enterprise.

Instead of or in addition to the non-disclosure enterprise ID list, a non-disclosure member ID list for registering a member ID to which disclosure of the recruitment case is prohibited may be provided in recruitment case database 124. Recruiter apparatus 200 may receive an operation of designating a member to whom disclosure of the recruitment case is prohibited, and transmit the ID of the member to sharing server 100. Sharing server 100 may not provide a member corresponding to a member ID listed in the non-disclosure member ID list with a recruitment case corresponding to the list. Thus, recruiter apparatus 200 may receive either an enterprise or a member as a target to which disclosure of a business is prohibited.

FIG. 14 is a diagram for illustrating a procedure of searching for a recruitment case from database 120. The processes of step S6 and step S7 in FIG. 11 and the function of case extraction unit 145 will be described in more detail with reference to FIG. 14.

When applicant apparatus 300 receives an operation of the applicant requesting a search for a recruitment case, applicant apparatus 300 executes a search process for the recruitment case (step S6). In the search process for the recruitment case, applicant apparatus 300 transmits a search request to case extraction unit 145 of sharing server 100.

When case extraction unit 145 receives the search request, case extraction unit 145 extracts cases allowed to be browsed by the applicant from the recruitment cases registered in recruitment case database 124. For this purpose, case extraction unit 145 executes the processes of steps S1451 to S1454.

Steps S1451 and S1452 are processes for extracting cases that are allowed to be browsed by the applicant based on the disclosure range set in the recruitment case. In step S1451, the enterprise to which the applicant belongs and the community of the enterprise to which the applicant belongs are determined. In step S1452, a case that can be disclosed is extracted.

Step S1453 is a process of extracting a case which is allowed to be browsed by the applicant based on the available capacity for sideline of the applicant. Step S1454 is a process of finally extracting a case matching the applicant.

### [Process of Extracting Case Based on Disclosure Range]

Step S1451 includes step S1451A and step S1451B.

In step S1451A, the enterprise to which the applicant belongs is identified based on the member ID used in the sign-in, enterprise database 121, and member database 122.

In step S1451B, the community of the enterprise to which the applicant belongs is identified based on the ID of the enterprise to which the applicant belongs and community database 123.

Step S1452 includes step S1452A and step S1452B.

In step S1452A, a recruitment case which can be disclosed is extracted from recruitment case database 124 based on the community of the enterprise to which the applicant belongs and the disclosure level.

In step S1452B, the recruitment case, in which the enterprise to which the applicant belongs is present in the non-disclosure enterprise list, is excluded from the recruitment cases extracted in step S1452A. Here, the case extracted by the process of step S1452B is referred to as case X.

### [Process of Extracting Case Based on Available Capacity for Sideline]

Step S1453 includes step S1453A, step S1453B, and step S1453C.

In step S1453A, hours T1 available for sideline of the applicant are calculated. The hours available for sideline are derived by calculating “maximum sideline hours−total sideline hours”. The maximum sideline hours are hours determined by the enterprise to which the applicant belongs, and are registered in enterprise database 121. The calculated hours available for sideline are registered in member database 122. Case extraction unit 145 may calculate the hours available for sideline of all the members at a constant time interval and register the calculated hours available for sideline in member database 122.

The total sideline hours are calculated based on a calculation formula of “total expected hours of the sidelines+total hours spent in achieving the sidelines” based on the expected hours of the sidelines and the hours spent in achieving the sidelines registered in sideline database 125. That is, the total sideline hours include the hours already spent on the sidelines and the expected hours not yet spent on the sidelines.

In step S1453B, hours T2 for handling the business are calculated for each of the recruitment cases. Hours T2 are calculated based on the assumed man-hours (man-months) and the assumed period registered in recruitment case database 124. For example, the hours of the assumed man-hours (man-months) may be adopted as hours T2. For example, 5 hours per month may be set as hours T2 for the recruitment case corresponding to case ID001.

In step S1453C, the recruitment case corresponding to “hours T2<hours T1 available for sideline” is extracted from recruitment case database 124. Here, the case extracted by the process of step S1453C is referred to as case Y.

### [Process of Extracting Case Based on Disclosure Range and Available Capacity for Sideline]

Case extraction unit 145 extracts case X based on the disclosure range, extracts case Y based on the available capacity for sideline, and then extracts cases overlapping between case X and case Y as matching cases of the applicant (step S1454).

### [Process of Providing Extracted Cases]

Next, case extraction unit 145 transmits information on the matching cases to applicant apparatus 300 (step S1455). Applicant apparatus 300 receives the matching cases. Applicant apparatus 300 displays a list of the received matching cases as recruitment cases on display 305 (step S7).

Thus, the recruitment cases which are suitable for the applicant are provided from two viewpoints. That is, first, a recruitment case that can be handled within a range which does not exceed the maximum sideline hours of the applicant is provided to the applicant. This can prevent the applicant from falling into an overworked state. Second, a recruitment case of the recruiter is provided only to the applicants belonging to the disclosure range intended by the recruiter. Thus, the confidential information on the enterprise to which the recruiter belongs can be prevented from leaking to a competitor.

### [Process of Registering Scheduled Hours of Sideline and Hours Spent in Achieving Sideline]

FIG. 15 is a diagram for illustrating a procedure of registering a schedule and an achievement of a sideline in database 120. Step S14 and the function of achievement receiving unit 149 in FIG. 12 will be described in more detail with reference to FIG. 15.

The applicant, for example, inputs the scheduled hours of the sideline to applicant apparatus 300 after receiving an order for a new sideline, and inputs the hours spent in achieving the sideline to applicant apparatus 300 at an arbitrary timing while being engaged in the sideline. Applicant apparatus 300 receives the input of the scheduled hours of the sideline (step S14). Applicant apparatus 300 transmits the received scheduled hours of the sideline and hours spent in achieving the sideline to achievement receiving unit 149 of sharing server 100.

Achievement receiving unit 149 receives the scheduled hours of the sideline and the hours spent in achieving the sideline of the applicant, and registers the received scheduled hours of the sideline and hours spent in achieving the sideline of the applicant in sideline database 125 (step S1511). Thus, the monthly scheduled hours of the sideline and hours spent in achieving the sideline of the applicant are registered in sideline database 125 for each case ID.

Usually, after the applicant inputs the scheduled hours of the sideline, the applicant inputs the hours spent in achieving the sideline at the end of the month. Therefore, sideline database 125 may include a case in which the scheduled hours of the sideline are registered but the hours spent in achieving the sideline are not registered. For example, at the stage when the applicant who has received an order for a sideline has input the scheduled hours of the sideline, the scheduled hours of the sideline are registered as data corresponding to the sideline, but the hours spent in achieving the sideline are not registered.

Next, achievement receiving unit 149 automatically calculates the expected hours of the sideline in the current month (step S1512). Achievement receiving unit 149 calculates the expected hours of the sideline based on the scheduled hours of the sideline and the hours spent in achieving the sideline. Specifically, as already described, the “expected hours of the sideline” is calculated based on the calculation formula of “(man-hour progress rate/progress rate)×scheduled hours of the sideline−hours spent in achieving the sideline”. Achievement receiving unit 149 may calculate the “expected hours of the sideline” based on a calculation formula of “scheduled hours of the sideline−hours spent in achieving the sideline”. Achievement receiving unit 149 registers the calculated expected hours of the sideline in sideline database 125. As shown in sideline database 125 of FIG. 7, the expected hours of the sideline are registered for each case ID.

### [Process of Registering Evaluation Result]

FIG. 16 is a diagram for illustrating a procedure of registering an evaluation of an applicant in database 120. Step S16 and the function of evaluation receiving unit 151 in FIG. 12 will be described in more detail with reference to FIG. 16.

When the applicant completes the sideline, the applicant reports the delivery and completion to the recruiter, and receives inspection from the recruiter. Thereafter, the recruiter operates recruiter apparatus 200 to input the evaluation of the applicant to recruiter apparatus 200. Recruiter apparatus 200 receives the input evaluation (step S16). Recruiter apparatus 200 transmits the received evaluation to evaluation receiving unit 151 of sharing server 100. The information transmitted from recruiter apparatus 200 to sharing server 100 includes the member ID and an evaluation value (0 to 10) of the applicant who is the person to be evaluated.

When evaluation receiving unit 151 receives the information on the evaluation of the person to be evaluated from recruiter apparatus 200, evaluation receiving unit 151 reflects the evaluation of the person to be evaluated in evaluation input database 126 (step S1513).

When an evaluation result of the recruiter (evaluator) for the person to be evaluated has already been registered in evaluation input database 126, evaluation receiving unit 151 calculates the average value of the evaluation results of the evaluator for the person to be evaluated including the value of the evaluation received this time. Evaluation receiving unit 151 updates the evaluation result registered in evaluation input database 126 with the calculated average value. As a result, the average value of the evaluation (evaluation result) for the person to be evaluated is registered in evaluation input database 126 for each evaluator.

Next, evaluation receiving unit 151 executes an evaluation summary process (step S1514). In the evaluation summary process, evaluation receiving unit 151 calculates an average value of the evaluation results for the person to be evaluated for each enterprise and each department, and registers the calculation result in evaluation summary database 127.

For example, evaluation receiving unit 151 identifies the evaluator using the member ID which is used by recruiter apparatus 200 for sign-in to execute step S16. Evaluation receiving unit 151 identifies the ID of the enterprise to which the evaluator belongs, the department to which the evaluator belongs, the member ID of the person to be evaluated, and the ID of the enterprise to which the person to be evaluated belongs, based on the information on the evaluation received in step S1513, enterprise database 121, and member database 122. The “member ID” is an example of “identification information that enables sharing server 100 including evaluation receiving unit 151 to identify the affiliation (enterprise and department) of a person who has accessed sharing server 100”.

Evaluation receiving unit 151 accesses evaluation summary database 127 and detects a data row in which the identified IDs (the member ID of the person to be evaluated, the ID of the enterprise to which the person to be evaluated belongs, and the ID of the enterprise to which the evaluator belongs) are arranged. Evaluation receiving unit 151 updates the value of the evaluation summary corresponding to the detected data row.

For example, in data group 127A of FIG. 9, the member ID of the person to be evaluated=P7, the ID of the enterprise to which the person to be evaluated belongs=00C, and the ID of the enterprise to which the evaluator belongs=00A are arranged. When a member belonging to the system department of enterprise A evaluates member P7, the evaluation is received in step S1513.

In this case, in step S1514, the evaluation received in step S1513 is reflected in the evaluation summary corresponding to “all” and the evaluation summary corresponding to “system department” of data group 127A.

More specifically, evaluation receiving unit 151 sets the average value of the evaluations of entire enterprise C including the evaluation received in step S1513 as the evaluation summary corresponding to “all” of data group 127A. Similarly, evaluation receiving unit 151 sets the average value of the evaluations of the system department including the evaluation received in step S1513 as the evaluation summary corresponding to “system department” of data group 127A.

FIG. 17 is a diagram for illustrating a procedure of displaying an evaluation for an applicant and a search result of a member on display 305. Step S4 (process of recruiter apparatus 200) and the function of member search unit 143 in FIG. 10, and step S17 and the function of evaluation output unit 152 in FIG. 12 will be described in more detail with reference to FIG. 17.

### [Process of Outputting Evaluation Summary of Applicant]

When recruiter apparatus 200 receives an operation allowing the recruiter to browse the evaluation of the applicant, recruiter apparatus 200 executes a browsing request process (step S17). In the browsing request process, recruiter apparatus 200 transmits a browsing request to evaluation output unit 152 of sharing server 100. In response to the browsing request, evaluation output unit 152 selects an evaluation summary for which the recruiter (browsing requester) has the browsing authority from evaluation summary database 127 (step S1521).

The recruiter who has made the browsing request is authorized to browse the evaluation summary of the entire enterprise to which the recruiter belongs and the evaluation summary of the department to which the recruiter belongs. The recruiter who has made the browsing request is not authorized to browse evaluation summaries other than these. Evaluation output unit 152 determines the browsing authority based on the member ID of the recruiter who transmits the browsing request, enterprise database 121, and member database 122. The “member ID” is an example of “identification information that enables sharing server 100 including evaluation receiving unit 151 to identify the affiliation (enterprise and department) and the browsing authority of a person who has accessed sharing server 100”.

Evaluation output unit 152 selects an evaluation summary corresponding to the browsing authority from evaluation summary database 127. Evaluation output unit 152 transmits data including the selected evaluation summary to recruiter apparatus 200 (step S1522). The transmitted data includes the member ID of the applicant (person to be evaluated), information on the enterprise to which the applicant belongs, information on the department to which the applicant belongs, and the like, in addition to the evaluation summary. When there is a selection target of evaluation output unit 152, the transmitted data includes evaluation summaries corresponding respectively to a plurality of applicants (persons to be evaluated).

Recruiter apparatus 200 which has received the evaluation summary displays the evaluation summary of the applicant on display 205 together with information on the enterprise to which the applicant belongs and information on the department to which the applicant belongs (step S18). When the evaluation summaries corresponding respectively to the plurality of applicants (persons to be evaluated) are received, recruiter apparatus 200 displays the evaluation summaries by listing the plurality of applicants (persons to be evaluated).

Thus, when sharing server 100 receives a browsing request in communication established by a member ID by which an enterprise and a department to which a recruiter belongs can be identified, sharing server 100 transmits an evaluation summary as an example of evaluation information to recruiter apparatus 200 of the recruiter who is a transmission source that has transmitted the browsing request.

### [Process of Searching Member]

Recruiter apparatus 200 executes a member search process after receiving a search operation by a person who recruits a vendor for a business (step S4). In the member search process, recruiter apparatus 200 transmits a search request to member search unit 143 of sharing server 100. For example, the search request includes a reference value for excluding members with low evaluation in the member search.

Member search unit 143 that has received the search request identifies the enterprise to which the recruiter who has transmitted the search request belongs (step S1431). Here, the enterprise identified in step S1431 is referred to as “enterprise X”.

Member search unit 143 identifies the recruiter who operates recruiter apparatus 200 using the member ID which is used when recruiter apparatus 200 signs in to sharing server 100. Member search unit 143 identifies enterprise X to which the recruiter belongs using enterprise database 121 and member database 122.

Next, member search unit 143 extracts members whose value of the evaluation summary of entire identified enterprise X exceeds the reference value from evaluation summary database 127 (step S1432). That is, member search unit 143 excludes members having low evaluation of entire enterprise X to extract a search result. Sharing server 100 may have a function of receiving setting information on the reference value from recruiter apparatus 200 of each enterprise. Thus, each enterprise can exclude members having low evaluation based on its own reference value from the search result.

Next, member search unit 143 outputs the extracted member information as a search result to recruiter apparatus 200 that has made the search request (step S1433). Recruiter apparatus 200 displays the received search result in a list on display 205 (step S19).

As a result, the recruiter can browse the search result excluding members with low overall evaluation of the enterprise to which the recruiter belongs on display 205. Therefore, when selecting a vendor from applicants, the recruiter can save the trouble of visually excluding members whose overall evaluation of the enterprise is low.

According to the present embodiment, when a member has a low evaluation in a certain department of the enterprise to which the recruiter belongs, the member is still not excluded from the search result if the evaluation of the entire enterprise is not low. However, member search unit 143 may further exclude such members from the search result.

### [Browsable Range of Evaluation Summary Database 127]

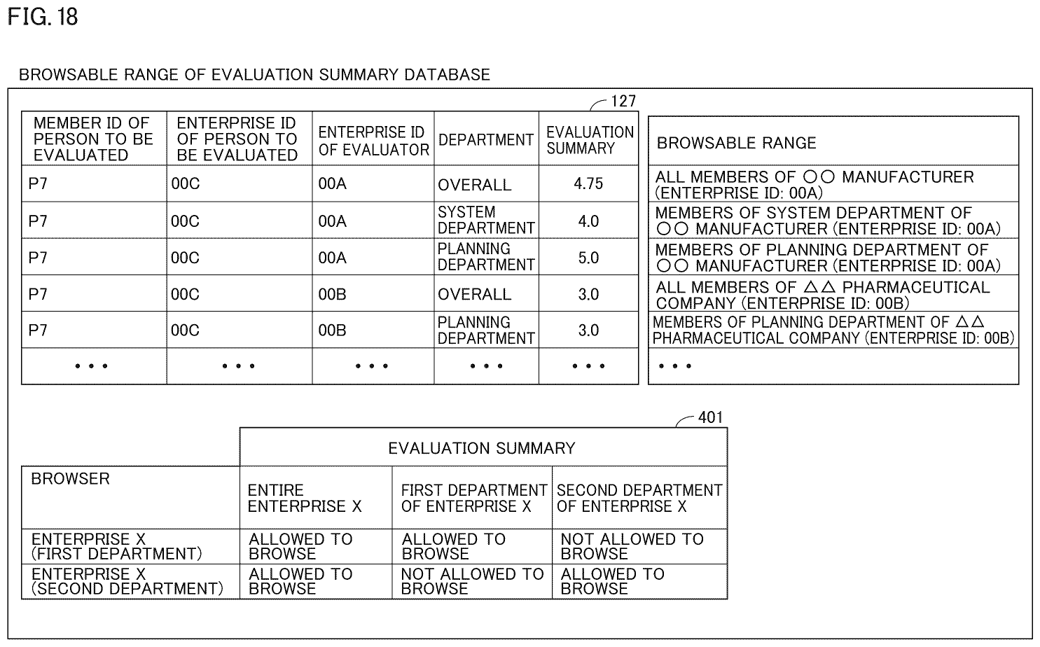

FIG. 18 is a diagram for illustrating a browsable range of evaluation summary database 127. As shown in FIG. 18, the browsing authority for the evaluation summary calculated from the evaluation of entire enterprise A is granted to all the members (recruiters) belonging to enterprise A.

The browsing authority for the evaluation summary calculated from the evaluation of the system department of enterprise A is granted to the members (recruiters) of the system department of enterprise A, but not granted to the members (recruiters) other than the system department of enterprise A. The browsing authority for the evaluation summary calculated from the evaluation of the planning department of enterprise A is granted to the members (recruiters) of the planning department of enterprise A, but not granted to the members (recruiters) other than the planning department of enterprise A.

The browsing authority for the evaluation summary calculated from the evaluation of entire enterprise B is granted to all the members (recruiters) belonging to enterprise B. The browsing authority for the evaluation summary calculated from the evaluation of the planning department of enterprise B is granted to the members (recruiters) of the planning department of enterprise B, but not granted to the members (recruiters) other than the planning department of enterprise B.

When the browsers are a member (recruiter) of the first department of enterprise X and a member (recruiter) of the second department of enterprise X, the browsers' authorities for the evaluation summary of entire enterprise X, the evaluation summary of the first department of enterprise X, and the evaluation summary of the second department of enterprise X are as shown in Table 401 of FIG. 18.

The evaluation summary of entire enterprise X, the evaluation summary of the first department of enterprise X, and the evaluation summary of the second department of enterprise X are shared by enterprise X, but are not disclosed to members of enterprises other than enterprise X. Therefore, for example, even when an employee of enterprise Y who has contracted the recruitment business of enterprise X has not performed the job well, the recruiter of enterprise X can evaluate the employee of enterprise Y by an objective scale without considering the relation between the enterprises, etc.

Further, since the evaluation is shared in enterprise X as an evaluation summary, the evaluator can be made aware that the accumulation of evaluations one by one produces useful information. This provides the evaluator with a motivation to make an accurate evaluation. As a result, the accuracy of the evaluation summary is improved. Thus, the evaluation summary can be usefully leveraged as reference data for selecting a vendor.

Further, according to the present embodiment, when the member search process (step S4) is executed in recruiter apparatus 200, the search result excluding the members with low evaluation is provided to the recruiter (step S1432). That is, matching system 1 has a filtering function of providing a search result excluding members with low evaluation.

Therefore, the recruiter can prevent the members with low evaluation from being adopted by mistake on an enterprise-by-enterprise basis when determining the vendor for the recruitment business. Sharing server 100 may perform filtering using the evaluation summary for each department.

A command signal for commanding which of filtering using the evaluation summary of the entire enterprise and filtering using the evaluation summary of each department is used may be transmitted from recruiter apparatus 200 to sharing server 100. In this case, sharing server 100 is provided with a function of changing the evaluation summary used for filtering in response to the command signal.

[Example in which Disclosure Range is Set in Accordance with Disclosure Level]

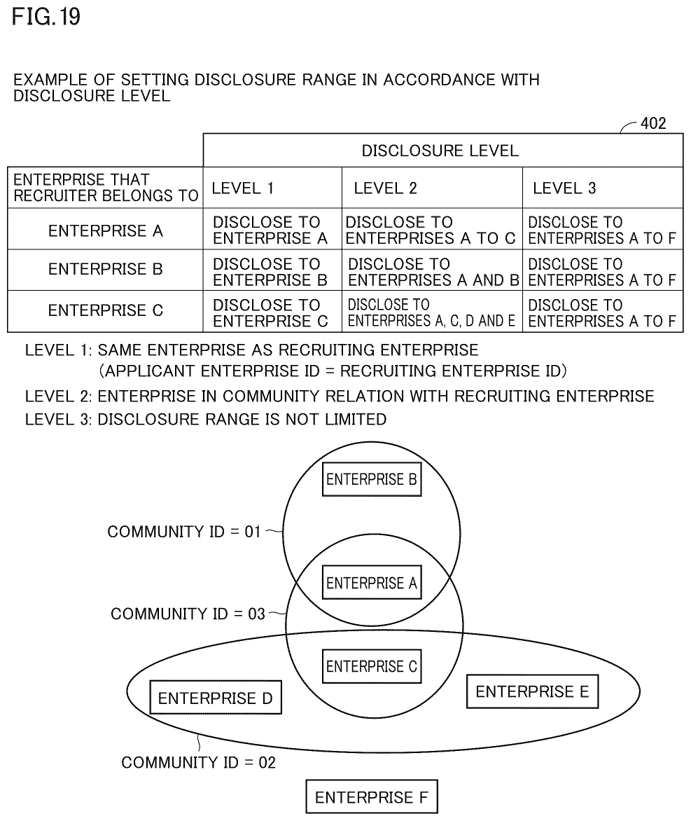

FIG. 19 is a diagram showing an example in which a disclosure range is set in accordance with a disclosure level. Here, as shown in FIG. 19, a case where enterprises A to E form a community relation and enterprise F does not have a community relation with any enterprise is considered. In this case, the disclosure range of the recruitment case is as shown in Table 402 in accordance with the enterprise to which the recruiter belongs and the disclosure level set by the recruiter.

The disclosure levels of “level 1” to “level 3” shown in FIG. 19 correspond to the three levels of “in-house”, “within community”, and “all” described above. Therefore, at level 1, the recruitment case of the recruiter is disclosed only to the applicants of the same enterprise as the enterprise to which the recruiter belongs. At level 2, in addition to the range of level 1, the recruitment case of the recruiter is disclosed to the applicants who belong to an enterprise having a community relation with the enterprise to which the recruiter belongs. At level 3, the recruitment case of the recruiter is disclosed to applicants belonging to all enterprises including the enterprise to which the recruiter belongs. Here, when the recruiter designates an ID of a non-disclosure enterprise, the enterprise corresponding to the enterprise ID is excluded from the enterprises which are disclosure targets regardless of the set disclosure level. Among the disclosure levels of the present embodiment, “level 1” corresponds to “allowing disclosure of the business information to the first applicant and prohibiting disclosure of the business information to an applicant who does not belong to the first group”. “Level 2” corresponds to “allowing disclosure of the business information to an applicant belonging to either the first group or a community group having a community relation formed with the first group, and prohibiting disclosure of the business information to an applicant not belonging to either the first group or the community group”. “Level 3” corresponds to “allowing disclosure of the business information to the applicant regardless of the group to which the applicant belongs”.

Here, as an example of a plurality of types of disclosure levels, the above level 1 to level 3 have been described. However, a plurality of types of disclosure levels is not limited to these. For example, a community may be divided into a plurality of small communities, and whether or not to disclose the recruitment business may be set for each small community. More specifically, community 02 shown in FIG. 5 is divided into a first small community and a second small community. It is assumed that enterprise C belongs to the first small community and enterprises D and E belong to the second small community. In this case, the recruiter of enterprise D may be allowed to select either the range of the first small community or the range of the second small community as the disclosure range of the recruitment business of the recruiter.

Sharing server 100 may receive an operation of setting the disclosure range differently for each recruitment case. For example, a specific example in which the disclosure range is set differently for each recruitment case will be described by taking case 001 to case 003 as examples among a large number of recruitment cases.

For example, the disclosure range of recruitment case 001 may be limited to only enterprises A and C belonging to the community identified by community ID=03. Alternatively, the disclosure range of recruitment case 002 may be limited to only enterprises C and D belonging to the community identified by community ID=02. Alternatively, the disclosure range of case 003 may be limited to enterprises C, D, and C belonging to the community identified by community ID=02 and enterprises A and C belonging to the community identified by community ID=03.

### [Screen Example Displayed When Checking Sideline Status]

FIG. 20 is a diagram showing a screen displayed on applicant apparatus 300 of a manager when the manager (a superior of an applicant) checks a subordinate's sideline status. FIG. 20 shows an example in which the sideline status of the subordinate of the manager is displayed on applicant apparatus 300. Applicant apparatus 300 is provided with a keyboard 306A and a mouse 306B as an operation unit.

Here, the manager is, for example, a department manager of a sales department of enterprise C. Display 305 shows the sideline status of the employees belonging to the sales department. The manager can check the sideline status of the employees belonging to the sales department by designating any of a tab 307A, a tab 307B, a tab 307C . . . using keyboard 306A or mouse 306B. Therefore, the manager can manage the working hours of the subordinates so that the subordinates do not fall into an overworked state. The progress rate may also be displayed on the screen.

The “group by enterprise” and the “group by department in the same enterprise” in the present embodiment are examples of “group”. Applicants who do not belong to the enterprise, such as freelances, may constitute one “group”. A plurality of enterprises may constitute an “enterprise group”.

According to the present embodiment, the “enterprises that form a community relation” are an example of “community group”.

According to the present embodiment, the information on “non-disclosure target” included in the disclosure information is an example of “information that can be used to identify a target for whom disclosure of the business information is prohibited”.

The communication (S9 in FIG. 11) for transmitting approval information from applicant apparatus 300 of the manager functioning as an approver to approval unit 147 is performed in a logical communication path identified by the member ID of the approver. “Approval unit 147 receiving the approval information through such a communication path” is an example of “receiving the approval notification through communication involving the identification information on the approver of the first applicant”.

According to the present embodiment, the “evaluation summary” registered in evaluation summary database 127 is an example of “evaluation information based on the evaluation received from recruiter apparatus 200 functioning as an evaluator apparatus”.

According to the present embodiment, “recruiter apparatus 200A” operated by a recruiter belonging to enterprise A functions as an evaluator apparatus, and is an example of “first evaluator apparatus operated by one or more evaluators belonging to the first group”.

According to the present embodiment, “recruiter apparatus 200B” operated by a recruiter belonging to enterprise B functions as an evaluator apparatus, and is an example of “second evaluator apparatus operated by one or more evaluators belonging to a second group different from the first group”.

FIG. 18 illustrates a system department and a planning department as the departments of enterprise A. According to the present embodiment, “one of the system department and the planning department” is an example of “first division group” included in the first group, and the other is an example of “second division group” included in the first group.

Sharing server 100 extracts business information in which the working hours of the applicant do not exceed the maximum hours from the list of recruitment case database 124 based on the assumed man-hours registered in recruitment case database 124, the maximum sideline hours registered in enterprise database 121, the hours spent in achieving the sideline registered in sideline database 125, and the expected hours of the sideline registered in sideline database 125. Specifically, for example, when the applicant is engaged in a plurality of sidelines, sharing server 100 calculates a total value of the hours spent in achieving the sidelines corresponding respectively to the sidelines to obtain the total hours spent in achieving the sidelines, and calculates a total value of the expected hours of the sidelines corresponding respectively to the sidelines to obtain the total expected hours of the sidelines. Sharing server 100 adds the obtained total hours spent in achieving the sidelines and the obtained total expected hours of the sidelines to obtain the total sideline hours. Sharing server 100 obtains the hours available for sideline of the applicant by subtracting the total sideline hours from the maximum sideline hours of the applicant. Sharing server 100 searches the list of recruitment case database 124 for a case that can be handled in the obtained hours available for sideline. At this time, sharing server 100 calculates the hours for handling each of the recruitment cases based on the assumed man-hours of recruitment case database 124, and searches for recruitment cases within the range of the hours available for sideline. Here, the “maximum sideline hours” is an example of “maximum hours as the upper limit of the working hours of the applicant”, the “hours spent in achieving the sideline” is an example of “actual hours during which the applicant has worked to achieve the sideline”, and the “expected hours of the sideline” is an example of “hours which are expected to be the working hours of the applicant”. The maximum hours may be a set upper limit to the total hours of the main business hours and the sideline hours, rather than to the sideline hours only. First maximum hours may be the maximum hours for all the businesses including the main business and the sidelines, rather than the maximum sideline hours. First actual hours and first expected hours may be the total hours of all the businesses including the sidelines and the main business, rather than sideline hours only.

Recruiter apparatus 200 and applicant apparatus 300 may be thin client systems, etc. that utilize a virtual desktop infrastructure (VDI), as well as systems including all of the processor, the memory, the communication interface, and the input and output interface shown in FIG. 2. A thin client system utilizing VDI is a system in which a desktop environment on a server is transferred to a terminal at a remote location and utilized. Recruiter apparatus 200, applicant apparatus 300, and sharing server 100 are not necessarily independent apparatuses. When the thin client system described above is utilized, the functions of recruiter apparatus 200, applicant apparatus 300, and sharing server 100 can be provided on the same aggregation server.

Database 120 is not limited to a relational database, and may be an object-type database, a NoSQL-type database, or the like.

Sharing server 100 is an example of a computing apparatus. The computing apparatus may be configured of a server (an on-premises server, a cloud server, or the like), a serverless system, or the like. Here, the on-premises server is a server that is installed and managed in a facility managed within the enterprise. The cloud server is a server (borrowed server) provided by another business operator via a network. The serverless system is a system in which a computing memory function can be utilized without being aware of the presence of a server. The computing apparatus includes servers and serverless systems. The server includes on-premises servers and cloud servers.

### <Modification 1>

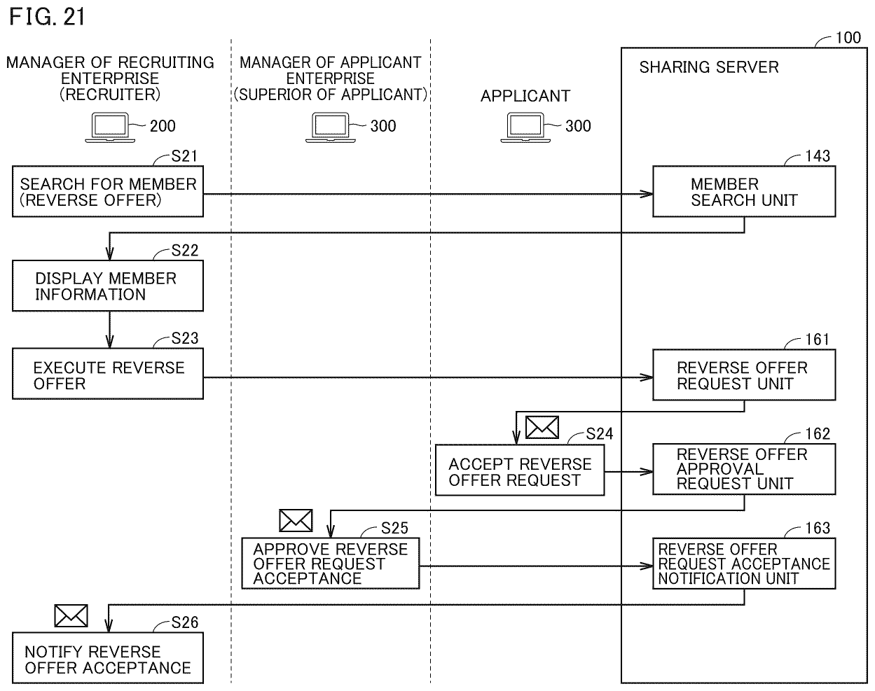

Next, Modification 1 will be described with reference to FIGS. 21 to 23. Modification 1 describes a reverse offer function that allows a recruiter to urge a person selected from a large number of members to join a recruitment business.

### [Background of Proposing Reverse Offer Function]

In crowdsourcing, generally, a recruiter discloses information on a recruitment case and waits for an application from a person who is interested in the content of the recruitment case. However, in such a method of recruiting, it may take time until a response is received from an applicant. Further, it is not clear whether or not there is an application from a person having a skill expected by the recruiter.

Therefore, it is conceivable that the recruiter searches for members and designates an appropriate member (reverse offer). However, it is difficult for the recruiter to designate a truly desired applicant in a state where only member IDs and names of the members are known to the recruiter. In addition, in order to prevent confidential information from leaking to enterprises or the like in a rival relation, member information on enterprises or the like in a rival relation should be excluded from the search result.

In view of such a background, according to Modification 1, a search result including detailed profile information on a member is provided to a recruiter who has performed a member search. Further, according to Modification 1, member information on an enterprise or the like having a rival relation with the enterprise or the like to which the recruiter belongs is excluded from the search result. Hereinafter, Modification 1 will be described in detail with reference to the drawings.

FIG. 21 is a diagram for illustrating functions of sharing server 100, recruiter apparatus 200, and applicant apparatus 300 according to Modification 1.

As shown in FIG. 21, sharing server 100 functionally includes a reverse offer request unit 161, a reverse offer approval request unit 162, and a reverse offer request acceptance notification unit 163 in addition to member search unit 143. These various functions are implemented by processor 101, memory 102, storage 103, and communication interface 104 included in sharing server 100.

Member search unit 143, as already described, has a function of searching for a member of matching system 1. In particular, according to Modification 1, member search unit 143 has a function of providing detailed profile information on the member to the searcher. Recruiter apparatus 200 executes a member search process after receiving a search operation by a recruiter (step S21). In particular, in step S21, recruiter apparatus 200 receives a search operation for the recruiter to make a reverse offer. Member search unit 143 provides information on members registered in member database 122 to recruiter apparatus 200. The information on the members to be provided includes detailed profile information on the members. Here, member search unit 143 excludes member information on an enterprise or the like having a rival relation with the enterprise or the like to which the recruiter belongs from the search result.

Recruiter apparatus 200 receives the member information (search result) from member search unit 143, and displays the member information as the search result on display 205 (step S22). Thereafter, recruiter apparatus 200 receives an operation of selecting an applicant from the search result by the recruiter. That is, the recruiter selects a member to whom a reverse offer is to be made based on the search result, and operates recruiter apparatus 200 to execute the reverse offer (step S23). Recruiter apparatus 200 transmits the member ID of the member who is the target of the reverse offer to sharing server 100.

Reverse offer request unit 161 receives the member ID of the member who is the target of the reverse offer from recruiter apparatus 200. Reverse offer request unit 161 identifies the member corresponding to the received member ID. Reverse offer request unit 161 notifies applicant apparatus 300 of the member who is the target of the reverse offer that the request of the reverse offer has been received. This notification may include information on the recruitment case which is the target of the reverse offer. The member who is the target of the reverse offer receives the request of the reverse offer through applicant apparatus 300. The “request” received here is an example of “information for urging the applicant to apply”. The member who is the target of the reverse offer determines whether or not to accept the request of the reverse offer. The member who is the target of the reverse offer can perform an operation of accepting the request of the reverse offer or an operation of rejecting the request of the reverse offer using applicant apparatus 300. Applicant apparatus 300 accepts the request of the reverse offer, for example (step S24). Applicant apparatus 300 that has accepted the request of the reverse offer transmits the application information to reverse offer approval request unit 162.

Reverse offer approval request unit 162 transmits the application information on the subordinate to the superior of the applicant. Reverse offer approval request unit 162 identifies the member ID of the superior who is the manager of the applicant based on the relation between the member ID of the applicant and the member ID of the superior registered in member database 122. The superior of the applicant checks the application information and approves the application on the superior's applicant apparatus 300 (step S25).

Reverse offer request acceptance notification unit 163 receives approval information from the superior of the applicant. Reverse offer request acceptance notification unit 163 accepts the application of the applicant on condition that the approval information is received. Reverse offer request acceptance notification unit 163 notifies recruiter apparatus 200 that the application from the member who has executed the reverse offer has been accepted. Recruiter apparatus 200 notifies the recruiter that the reverse offer has been accepted based on the notification (step S26). More specifically, recruiter apparatus 200 displays information for notifying the recruiter that the reverse offer has been accepted on display 205.

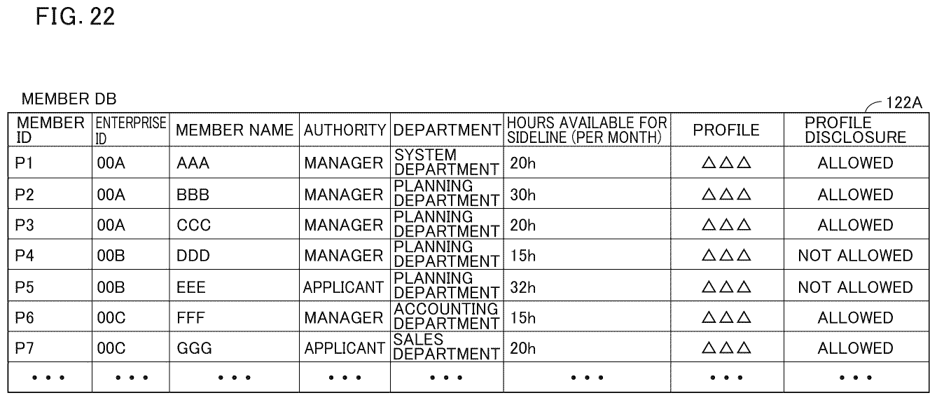

FIG. 22 is a diagram showing an example of member database 122A according to Modification 1. Compared to member database 122 shown in FIG. 4, member database 122A shown in FIG. 22 has added profile information and profile public information indicating whether or not to make the profile public.

Matching system 1 gives the member the authority to register and modify the member's profile information in member database 122A using applicant apparatus 300. The member registers various profile information on the member in member database 122A using applicant apparatus 300. The profile information includes, for example, information on a synthetic personality inventory (SPI) of the member, a job history of the member, achievements of the member, qualifications of the member, etc.

The member sets the profile public information using applicant apparatus 300. The profile information on the member whose profile public information is set to allow disclosure is provided to the searcher. The profile information on the member whose profile public information is set to forbid disclosure is not provided to the searcher. Sharing server 100 registers the profile public information in member database 122A based on the setting selected by each member. Thus, sharing server 100 receives an input of information indicating whether or not to allow the inclusion of profile information in the search result from each of a plurality of members.

Here, an example, in which whether or not the disclosure of the profile information on the member is allowed is determined based on the setting of the profile public information, has been described. However, sharing server 100 may receive a setting operation of whether to allow disclosure for each type of profile information. Thus, for example, the member can set the achievements and qualifications as disclosure targets, while set the information on the SPI as a non-disclosure target. Alternatively, when age is included in the profile information, the member can set the age as a non-disclosure target and set the other profile information as disclosure targets. In this case, sharing server 100 registers a plurality of pieces of profile information on each of a plurality of registrants (members) in member database 122A. Sharing server 100 receives an input for setting a range to be disclosed as a search result among the plurality of pieces of profile information from each of the plurality of registrants.

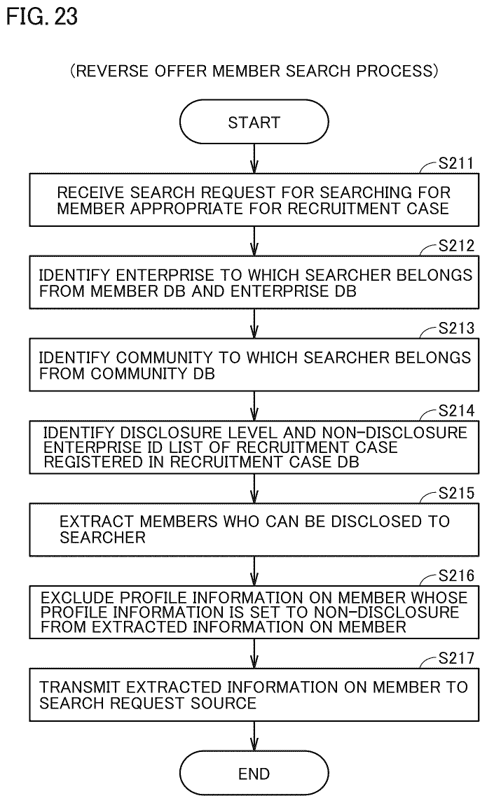

FIG. 23 is a flowchart showing a processing procedure of a reverse offer member search process according to Modification 1. The process based on the flowchart is executed by sharing server 100.

First, sharing server 100 receives a search request for a searcher to search for a member appropriate for a recruitment case (step S211). Here, the searcher is a recruiter who has a recruitment case. The recruiter searches for members using the recruiter's recruiter apparatus 200 in order to make a reverse offer to a member having a skill appropriate for the recruitment case. The search request of the recruiter is received by sharing server 100 in step S211. The search request may include the member ID of the searcher and the case ID of the recruitment case.

Next, sharing server 100 identifies the enterprise to which the searcher belongs from member database 122A and enterprise database 121 (step S212). Next, sharing server 100 identifies the community to which the searcher belongs from community database 123 (step S213).

Next, sharing server 100 identifies the disclosure level and the non-disclosure enterprise ID list of the recruitment case registered in recruitment case database 124 (step S214). Next, sharing server 100 extracts members who can be disclosed to the searcher (step S215).

More specifically, sharing server 100 identifies enterprises, to which the recruitment case held by the searcher (recruiter) should not be disclosed, based on the non-disclosure enterprise list and the disclosure level of recruitment case database 124. Sharing server 100 determines that the members belonging to such an enterprise cannot be disclosed to the searcher. Sharing server 100 extracts members other than the members belonging to such an enterprise as members who can be disclosed to the searcher.

Next, sharing server 100 refers to member database 122A to exclude the profile information on the member whose profile information is set to non-disclosure from the extracted information on the member (step S216).

Next, sharing server 100 transmits the extracted information on the member to a search request source (step S217), and ends the process based on the flowchart. Recruiter apparatus 200 of the search request source receives the information on the member transmitted from sharing server 100, and displays the information on display 205. The information displayed on display 205 includes the extracted ID, name, and profile information on each member. Here, for a member whose profile information is not disclosed, only the ID and name of the member are displayed, and the profile information of the member is not displayed.

As described above, according to Modification 1, the recruiter can search for a member who is considered to be most suitable for application to the recruitment business while referring to the detailed profile information on the member, and can make a reverse offer to the member. In addition, members such as enterprises to which the recruiter belongs and enterprises in rival relation with the community are excluded from the members displayed as the search result. Therefore, it is possible to prevent the inconvenience of the recruiter ordering the business from members of such rival enterprises. Furthermore, since members themselves can determine whether or not to disclose the profile information, a system in which the free will of each member is respected can be provided.

A member may be allowed to set whether or not to disclose not only the profile information but also the name. Further, several categories may be provided for the profile information, and the member may be allowed to set whether or not to disclose the profile information for each category.

By adding the offer function described above to matching system 1, the recruiter can check the profile information on the member who is allowed to browse the recruitment case. Further, the recruiter can urge the members, to whom the recruiter wants to place an order, to apply. The member who is urged to apply by the recruiter can browse the case information and accept or reject the case. Further, each member can determine whether or not to disclose the profile information at the time of registering the member information, editing the member information, or the like. Thus, the recruiter can actively select an offer destination and make the most suitable applicant engage in the business at an early stage.

### <Modification 2>

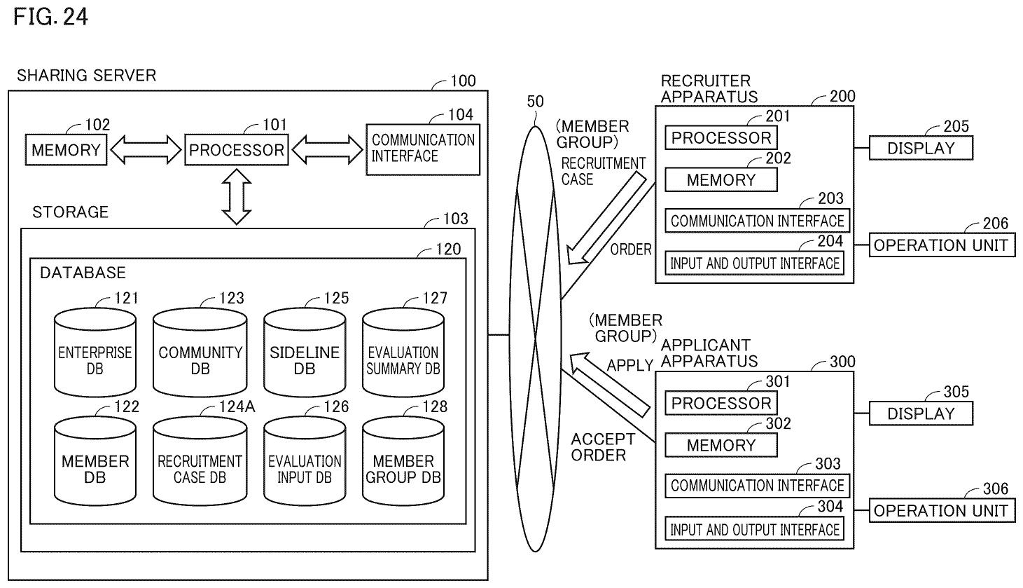

Next, a second modification will be described with reference to FIGS. 24 to 28. According to Modification 2, a member group application function will be described in which a plurality of members can apply for the recruitment business as a group.

### [Background of Proposing Member Group Application Function]

In crowdsourcing, generally, a recruiter discloses information on a recruitment case, and an individual who is interested in the content of the recruitment case applies for the recruitment. However, there are many cases that should be handled by a team of a plurality of persons, and many cases that are desirably handled by a team, such as a comprehensive business from business planning to acquisition of intellectual property rights related to the planning. Therefore, when the number of persons to be recruited is limited to one, it is difficult for a person who desires to accept an order to undertake more businesses than what can be handled by an individual.

In view of such a background, Modification 2 provides a member group application function that allows a plurality of members to apply for a recruitment business as a group. Modification 2 will be described in detail below.

FIG. 24 is a block diagram showing a configuration of sharing server 100, recruiter apparatus 200, and applicant apparatus 300 according to Modification 2. In the block diagram shown in FIG. 24, a member group database 128 is added as compared with the block diagram shown in FIG. 2. Recruitment case database 124A shown in FIG. 24 is obtained by adding a function of registering a recruitment case that allows application by a member group to recruitment case database 124 shown in FIG. 6.

A member group consisting of a plurality of members is registered in member group database 128. The recruiter can register a recruitment case that allows an application by a member group in recruitment case database 124A using recruiter apparatus 200. Applicants can apply as a member group registered in member group database 128 for the recruitment case which allows an application by the member group using applicant apparatus 300.

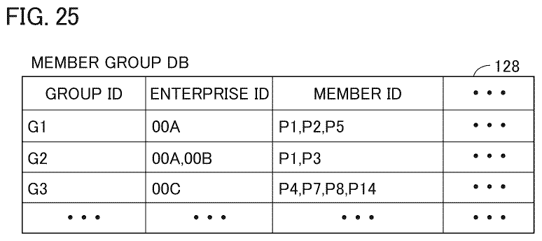

FIG. 25 is a diagram showing an example of member group database 128 according to Modification 2. Information on a member group is registered in member group database 128. The information on the member group includes a group ID for identifying the member group, an enterprise ID of an enterprise to which each member of the member group belongs, a member ID of each member of the member group, and the like.

Hereinafter, the member groups corresponding to each group ID may be referred to as member group G1, member group G2, member group G3 . . . using the group IDs.

Member group G1 is constituted of three members identified by member IDs=P1, P2, and P5. Since the enterprise ID registered in association with member group G1 is 00A, it is understood that all of the three members belong to enterprise A.

Member group G2 is constituted of two members identified by member IDs=P1 and P3. Since the enterprise IDs registered in association with member group G2 are 00A and 00B, it is understood that one of the two members belongs to enterprise A and the other belongs to enterprise B. As can be understood by comparing member group G1 and member group G2, member ID=P1 is registered in both member groups G1 and G2. Therefore, member P1 belongs to two member groups.

Member group G3 is constituted of four members identified by member IDs=P4, P7, P8, and P14. Since the enterprise ID registered in association with member group G3 is 00C, it is understood that all of the four members belong to enterprise C.

As shown in FIG. 24, member group database 128 is stored in storage 103 of sharing server 100. The member obtains consent from other members who have known the member through the same enterprise or community, etc. to form a member group, and registers the member group in member group database 128. The “member group” is an example of “application group”.

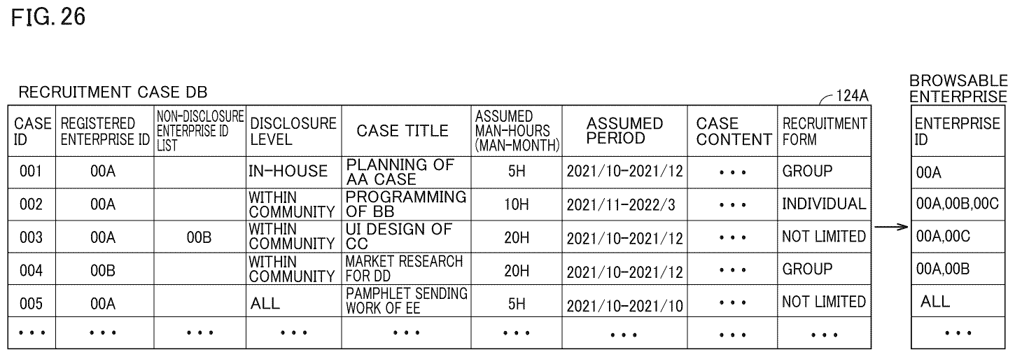

FIG. 26 is a diagram showing an example of recruitment case database 124A according to Modification 2. Recruitment case database 124A shown in FIG. 26 is different from recruitment case database 124 shown in FIG. 6 in that information on a recruitment form is added. The recruiter operates recruiter apparatus 200 to set the recruitment form. Sharing server 100 registers the recruitment form based on the setting in recruitment case database 124A in association with the business information.

The recruiter can select a recruitment form from a group form and an individual form. It is considered that when the recruiter does not select a recruitment form, the recruitment form of the recruitment case is not limited to the group form or the individual form. A case for which the recruitment form is set to be the group form can be ordered only by a member group. A case for which the recruitment form is set to be the individual form can be ordered only by an individual member. The case for which the recruitment form is not limited can be ordered by either a member group or an individual. The “information on the recruitment form” is an example of “information that can be used to identify that the business for which a vendor is recruited is to be jointly applied for by a plurality of recruiters”.

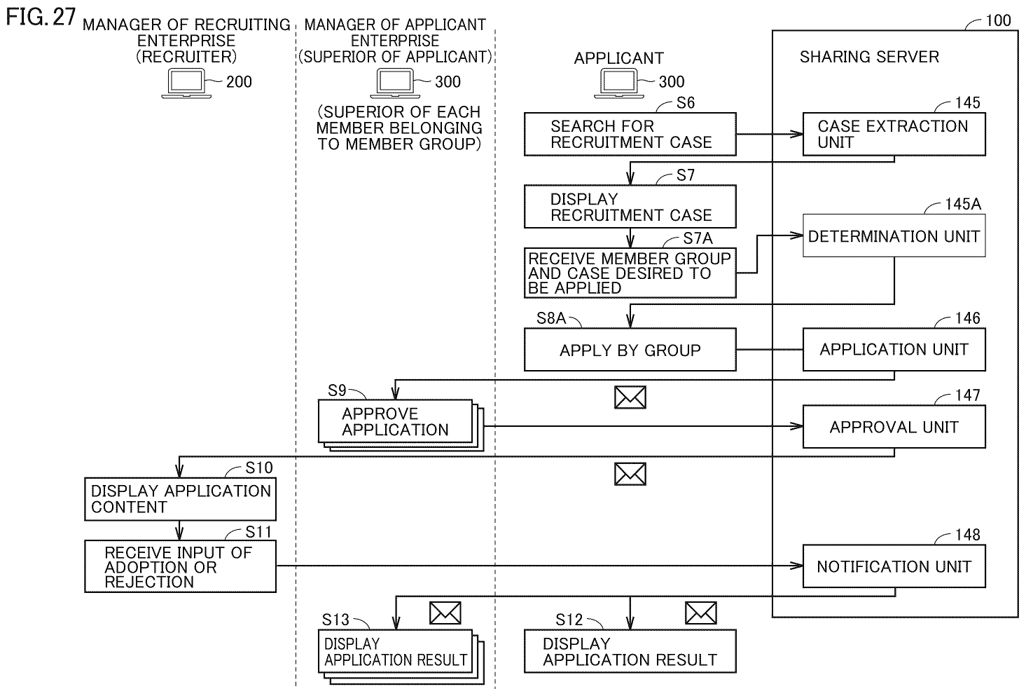

FIG. 27 is a diagram for illustrating functions of sharing server 100, recruiter apparatus 200, and applicant apparatus 300 according to Modification 2. In FIG. 27, a determination unit 145A is added to sharing server 100, compared to FIG. 11. In FIG. 27, step S7A is added after step S7, and step S8A for group application is adopted instead of step S8 for application, compared to FIG. 11.

Here, it is assumed that the applicant belongs to a plurality of member groups. The applicant operates applicant apparatus 300 to search for a recruitment case (step S6). Applicant apparatus 300 transmits the search request to case extraction unit 145 of sharing server 100.

When case extraction unit 145 receives the search request, as described with reference to FIG. 11, case extraction unit 145 extracts cases allowed to be browsed by the applicant from the recruitment cases registered in recruitment case database 124. The cases extracted by case extraction unit 145 include cases whose recruitment form is any of “group”, “individual”, and “not limited”. Case extraction unit 145 transmits the extracted recruitment cases to applicant apparatus 300. Applicant apparatus 300 receives the recruitment cases from case extraction unit 145. Applicant apparatus 300 displays the received recruitment cases on display 305 (step S7).

Display 305 displays, for each of the recruitment cases, a disclosure level, a case title, assumed man-hours, an assumed period, a case content, a recruitment form, and the like. When the applicant desires to apply as a member group, the applicant designates the member group and selects the case whose application form is “group” or “not limited” using operation unit 306 such as a mouse and a keyboard. Applicant apparatus 300 receives the member group and the case desired to be applied for based on the operation of the applicant (step S7A). Applicant apparatus 300 transmits the group ID of the received member group and the case ID of the received case to sharing server 100. Determination unit 145A of sharing server 100 acquires the group ID and the case ID.

Determination unit 145A accesses member group database 128 and identifies the member ID registered in association with the acquired group ID. Determination unit 145A accesses member database 122 and identifies the enterprise ID corresponding to the identified member ID.

Determination unit 145A accesses community database 123 and identifies the community ID of the community to which the enterprise with the identified enterprise ID belongs. Determination unit 145A accesses recruitment case database 124A, and identifies the enterprise ID (the enterprise ID of the recruiter), the non-disclosure enterprise IDs, the disclosure level, and the recruitment form registered in association with the acquired case ID.

Determination unit 145A determines whether or not the recruitment case received by applicant apparatus 300 is a case for which an application by the member group designated by the applicant is allowed, based on the information identified as described above. In other words, determination unit 145A determines whether or not to allow the application by the member group.

For example, determination unit 145A does not allow the application by the member group when one of the members in the member group belongs to an enterprise listed in the non-disclosure enterprise ID list corresponding to the recruitment case. Alternatively, determination unit 145A does not allow the application by the member group when one of the members in the member group belongs to an enterprise outside the community even though the disclosure level of the recruitment case is “within community”.

Determination unit 145A returns the determination result to applicant apparatus 300. FIG. 27 shows a flow in a case when determination unit 145A allows the application by the member group. When determination unit 145A allows the application by the member group, applicant apparatus 300 receives the application by the member group (step S8A). For example, applicant apparatus 300 displays, on display 305, a screen indicating that the application received in step S7A is allowed and a screen for checking whether or not to apply. The applicant selects an application using operation unit 306 such as a mouse and a keyboard.

When applicant apparatus 300 receives the application by the member group (step S8A), applicant apparatus 300 transmits the application information to sharing server 100. Application unit 146 of sharing server 100 acquires the application information. The contents of the subsequent processes are the same as the contents described with reference to FIG. 11. Here, application unit 146 transmits the application information to the superior of each member belonging to the member group. Therefore, the application approval process of step S9 is executed for each superior of each member belonging to the member group. Therefore, approval unit 147 receives approval information indicating approval of the application of the subordinate or rejection information indicating rejection of the application of the subordinate from a plurality of superiors.

Approval unit 147 accepts the application of the applicant only when approval information is obtained from all of the superiors of the members belonging to the member group. Approval unit 147 which has accepted the application of the applicant transmits application information to recruiter apparatus 200. As already described with reference to FIG. 11, recruiter apparatus 200 displays the application contents on display 205 (step S10). The recruiter inputs the result of the determination of adoption or rejection to recruiter apparatus 200. Recruiter apparatus 200 receives the input result (step S11), and transmits the received result of adoption or rejection to notification unit 148 of sharing server 100.

Notification unit 148 transmits the application result (the result of adoption or rejection) to applicant apparatus 300 of the applicant and applicant apparatus 300 of the superior (manager). Here, notification unit 148 transmits the application result to the superior of each member belonging to the member group.

Applicant apparatus 300 of the applicant and applicant apparatus 300 of the superior of each member belonging to the member group display the application result on display 305 (step S12, step S13). The applicant and the superior of each member belonging to the member group check the application result by viewing the display on display 305.

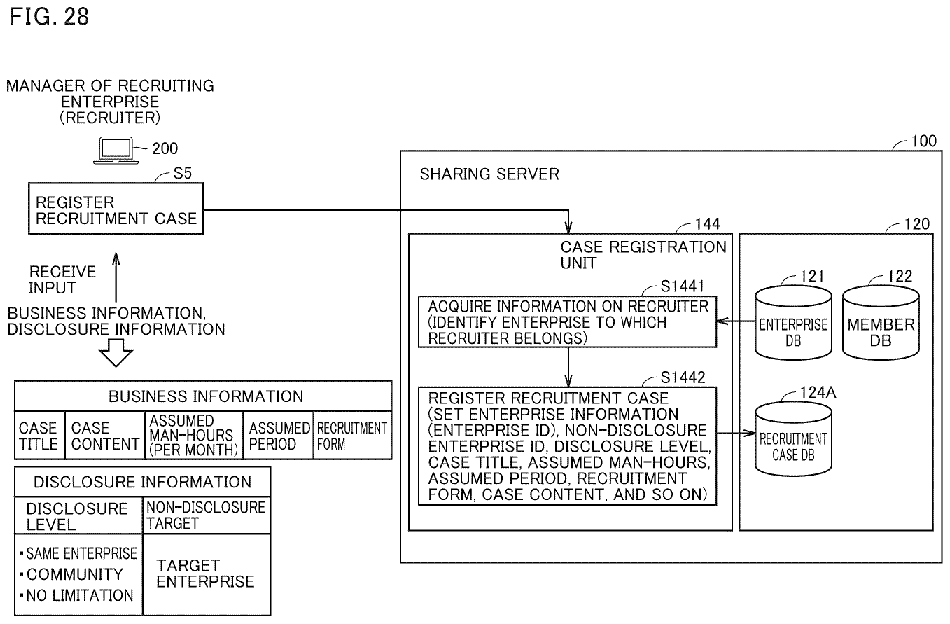

FIG. 28 is a diagram for illustrating a procedure of registering a recruitment case in recruitment case database 124A according to Modification 2. In FIG. 28, a recruitment form is added to the business information input to recruiter apparatus 200, as compared with FIG. 13.

According to Modification 2, when the recruiter who registers the recruitment case inputs the business information and the disclosure information on the recruitment case to recruiter apparatus 200, the recruitment form of the recruitment case can be included in the business information. The recruitment form is either the group form or the individual form. Case registration unit 144 of sharing server 100 registers the recruitment case including the recruitment form selected by the recruiter in recruitment case database 124A (step S1442). When the recruiter does not select the recruitment form, case registration unit 144 registers information indicating that the recruitment form is not limited in recruitment case database 124A. The other contents shown in FIG. 28 are the same as those in FIG. 13 that are already described, and therefore, the description thereof will not be repeated here.

As described above, according to Modification 2, a plurality of members can apply for a recruitment case as a group. Moreover, according to Modification 2, it is determined whether or not to allow the application of the member group based on the relation between the enterprise and the community to which the recruiter belongs and the enterprise and the community to which each member of the member group belongs. Therefore, it is possible to prevent a member group including a member belonging to an organization in a competitive relation with the applicant from receiving an order for the recruitment case of the applicant.

By adding the member group application function described above to matching system 1, it is possible to provide a system in which the vendor side can browse the recruitment case and apply for the recruitment case by the member group. Thus, matching system 1 can handle the placement and acceptance of orders of a large-scale business that is desirably handled by a team.

### Aspects

Aspects of the present disclosure are listed below.

(Aspect 1) An evaluation system according to Aspect 1 evaluates a vendor who has applied for a business, the evaluation system including: a first evaluator apparatus that is operated by one or more evaluators belonging to a first group; and a computing apparatus that communicates with the first evaluator apparatus and is accessible to a database, in which the first evaluator apparatus is configured to receive an input of an evaluation for the vendor and to transmit the evaluation which has been received to the computing apparatus, the computing apparatus is configured to register a first evaluation information based on the evaluation received from the first evaluator apparatus in the database for each vendor, and when the computing apparatus has received a browsing request in a first communication established by an identification information which is used to identify a person belonging to the first group, the computing apparatus is configured to transmit the first evaluation information to a transmission source which has transmitted the browsing request in the first communication.
(Aspect 2) An evaluation system according to Aspect 2 is the evaluation system according to Aspect 1, further including: a second evaluator apparatus that is operated by one or more evaluators belonging to a second group different from the first group, in which the second evaluator apparatus is configured to receive an input of an evaluation for the vendor and to transmit the evaluation which has been received to the computing apparatus, the computing apparatus is configured to register a second evaluation information based on the evaluation received from the second evaluator apparatus in the database for each vendor, and when the computing apparatus has received a browsing request in a second communication established by an identification information which is used to identify a person belonging to the second group, the computing apparatus is configured to transmit the second evaluation information to a transmission source which has transmitted the browsing request in the second communication.
(Aspect 3) An evaluation system according to Aspect 3 is the evaluation system according to Aspect 2, in which the first group is constituted of a first enterprise, and the second group is constituted of a second enterprise different from the first enterprise.
(Aspect 4) An evaluation system according to Aspect 4 is the evaluation system according to Aspect 2, in which the first group is constituted of a first department of a first enterprise, and the second group is constituted of a second department of the first enterprise.
(Aspect 5) An evaluation system according to Aspect 5 is the evaluation system according to any one of Aspects 1 to 4, in which when the computing apparatus has received evaluations for a predetermined vendor from a plurality of evaluators belonging to the first group, the computing apparatus is configured to calculate an average value of the evaluations which are made by the plurality of evaluators for the predetermined vendor, and the computing apparatus is configured to transmit the average value as the first evaluation information of the predetermined vendor to a transmission source which has transmitted the browsing request in the first communication.
(Aspect 6) An evaluation system according to Aspect 6 is the evaluation system according to any one of Aspects 1 to 3, in which the first group includes one or more evaluators belonging to a first division group and one or more evaluators belonging to a second division group different from the first division group, the computing apparatus is configured to calculate a first average value which is an average value of evaluations for the predetermined vendor based on the evaluations for the predetermined vendor received from a plurality of evaluators belonging to the first division group, the computing apparatus is configured to calculate a second average value which is an average value of evaluations for the predetermined vendor based on the evaluations for the predetermined vendor received from a plurality of evaluators belonging to the second division group, the computing apparatus is configured to calculate a third average value which is an average value of evaluations for the predetermined vendor based on the evaluations for the predetermined vendor received from a plurality of evaluators belonging to the first group, when the computing apparatus has received a browsing request in a third communication established by an identification information which is used to identify a person belonging to the first division group, the computing apparatus is configured to transmit the first average value and the third average value as the first evaluation information of the predetermined vendor to a transmission source which has transmitted the browsing request in the third communication, and when the computing apparatus has received a browsing request in a fourth communication established by an identification information which is used to identify a person belonging to the second division group, the computing apparatus is configured to transmit the second average value and the third average value as the first evaluation information of the predetermined vendor to a transmission source which has transmitted the browsing request in the fourth communication.
(Aspect 7) An evaluation system according to Aspect 7 is the evaluation system according to any one of Aspects 1 to 6, in which a list of vendors is registered in the database, the first evaluator apparatus is configured to transmit a search request to the computing apparatus when the first evaluator apparatus has received an operation of searching for the list, and when the computing apparatus has received the search request, the computing apparatus is configured to transmit a search result obtained by excluding vendors whose evaluation level identified through the first evaluation information does not satisfy a criterion from the list to the transmission source that has transmitted the browsing request in the first communication.
(Aspect 8) An evaluation system according to Aspect 8 is the evaluation system according to Aspect 2 or Aspect 3, in which a plurality of pieces of business information is registered in the database together with a disclosure information indicating a disclosure range to an applicant, the evaluation system further includes an applicant apparatus operated by an applicant belonging to the second group, and the computing apparatus is configured to determine, based on the disclosure information, business information allowed to be disclosed to the applicant belonging to the second group among the plurality of pieces of business information registered in the database, and to provide the business information allowed to be disclosed to the applicant belonging to the second group to the applicant apparatus.
(Aspect 9) An evaluator apparatus according to Aspect 9 is operated by one or more evaluators belonging to a first group, the evaluator apparatus including: an interface that receives an operation of inputting an evaluation for a vendor who has applied for a business; a receiving unit that receives a browsing request; a display; and a processor that transmits the evaluation received by the interface and the browsing request received by the receiving unit to a computing apparatus which is accessible to a database, in which the processor is configured to display the evaluation by the one or more evaluators belonging to the first group on the display when the browsing request is made.
(Aspect 10) A method according to Aspect 10 evaluates a vendor who has applied for a business, the method including: communicating with a first evaluator apparatus operated by one or more evaluators belonging to a first group; receiving an evaluation for the vendor from the first evaluator apparatus; registering a first evaluation information based on the evaluation received from the first evaluator apparatus in a database; and transmitting the first evaluation information to a transmission source that has transmitted a browsing request in a first communication when the browsing request has been received in the first communication established by an identification information which is used to identify a person belonging to the first group.

It should be understood that the embodiments disclosed herein are illustrative in all respects and are not restrictive. The scope of the present invention is defined not by the above description of the embodiments but by the claims, and is intended to include all modifications within the meaning and scope equivalent to the claims.

### REFERENCE SIGNS LIST

1: matching system, 50: internet, 100: sharing server, 101: processor, 102: memory, 103: storage, 104: communication interface, 120: database (DB), 121: enterprise database (enterprise DB), 122, 122A: member database (member DB), 123: community database (community DB), 124, 124A: recruitment case database (recruitment case DB), 125: sideline database (sideline DB), 126: evaluation input database (evaluation input DB), 127: evaluation summary database (evaluation summary DB), 127A, 127B: data group, 128: member group database (member group DB), 140: community registration unit, 141: enterprise registration unit, 142: member registration unit, 143: member search unit, 144: case registration unit, 145: case extraction unit, 145A: determination unit, 146: application unit, 147: approval unit, 148: notification unit, 149: achievement receiving unit, 150: achievement output unit, 151: evaluation receiving unit, 152: evaluation output unit, 161: reverse offer request unit, 162: reverse offer approval request unit, 163: reverse offer request acceptance notification unit, 200, 200A, 200B, 200C: recruiter apparatus, 201: processor, 202: memory, 203: communication interface, 204: input and output interface, 205: display, 206: operation unit, 206A: keyboard, 206B: mouse, 207: screen, 300, 300A, 300B, 300C: applicant apparatus, 301: processor, 302: memory, 303: communication interface, 304: input and output interface, 305: display, 306: operation unit, 306A: keyboard, 306B: mouse, 307A to 307C: tab, 401, 402: table.

1. An evaluation system that evaluates a vendor who has applied for a business, the evaluation system comprising:
a first evaluator apparatus that is operated by one or more evaluators belonging to a first group;
a second evaluator apparatus that is operated by one or more evaluators belonging to a second group different from the first group; and
a computing apparatus that is configured to communicate with the first evaluator apparatus and to access a database,
wherein the first evaluator apparatus is configured to receive an input of a first evaluation for the vendor, and to transmit the first evaluation to the computing apparatus,
wherein the second evaluator apparatus is configured to receive an input of a second evaluation for the vendor, and to transmit the second evaluation to the computing apparatus,
wherein the computing apparatus is further configured to register a first evaluation information based on the first evaluation in the database for the vendor, and to register a second evaluation information based on the second evaluation in the database for the vendor,
wherein when the computing apparatus receives from a transmission source a browsing request in a first communication established by identification information that identifies a person belonging to the first group, the computing apparatus is configured to transmit the first evaluation information to the transmission source of the first communication and not transmit the second evaluation information to the transmission source of the first communication, and
wherein when the computing apparatus receives from a transmission source a browsing request in a second communication established by identification information that identifies a person belonging to the second group, the computing apparatus is configured to transmit the second evaluation information to the transmission source of the second communication, and not transmit the first evaluation information to the transmission source of the second communication.

2. The evaluation system according to claim 1, wherein the first group comprises a first enterprise, and the second group comprises a second enterprise different from the first enterprise.

3. The evaluation system according to claim 1, wherein the first group comprises a first department of a first enterprise, and the second group comprises a second department of the first enterprise.

4. The evaluation system according to any one of claim 1, wherein when the computing apparatus receives from the transmission source of the first communication evaluations for a predetermined vendor from a plurality of evaluators belonging to the first group, the computing apparatus is configured to:
calculate an average value of the evaluations, and
transmit the average value as the first evaluation information of the predetermined vendor to the transmission source of the first communication.

5. An evaluation system that evaluates a vendor who has applied for a business, the evaluation system comprising:
a first evaluator apparatus that is operated by one or more evaluators belonging to a first group; and
a computing apparatus that is configured to communicate with the first evaluator apparatus and to access to a database,
wherein the first evaluator apparatus is configured to receive an input of an evaluation for the vendor and to transmit the evaluation to the computing apparatus,
wherein the computing apparatus is configured to register a first evaluation information based on the evaluation received from the first evaluator apparatus in the database for each vendor,
wherein when the computing apparatus receives from a transmission source a browsing request in a first communication established by identification information that identifies a person belonging to the first group, the computing apparatus is configured to transmit the first evaluation information to the transmission source,
wherein the first group comprises one or more evaluators belonging to a first division group and one or more evaluators belonging to a second division group different from the first division group,
wherein the computing apparatus is configured to calculate a first average value as an average of evaluations received from a plurality of evaluators belonging to the first division group,
wherein the computing apparatus is configured to calculate a second average value as an average of evaluations received from a plurality of evaluators belonging to the second division group,
wherein the computing apparatus is configured to calculate a third average value as an average of evaluations from a plurality of evaluators belonging to the first group,
wherein when the computing apparatus receives from a transmission source a browsing request in a third communication established by identification information that identifies a person belonging to the first division group, the computing apparatus is configured to transmit the first average value and the third average value as the first evaluation information of the predetermined vendor to the transmission source of the third communication, and
wherein when the computing apparatus receives from a transmission source a browsing request in a fourth communication established by identification information that identifies a person belonging to the second division group, the computing apparatus is configured to transmit the second average value and the third average value as the first evaluation information of the predetermined vendor to the transmission source of the fourth communication.

6. The evaluation system according to claim 1,
wherein a list of vendors is registered in the database,
wherein the first evaluator apparatus is configured to transmit a search request to the computing apparatus when the first evaluator apparatus receives an operation of searching for the list, and
wherein when the computing apparatus receives the search request, the computing apparatus is configured to transmit a search result obtained by excluding vendors whose evaluation level identified through the first evaluation information does not satisfy a criterion from the list to the transmission source of the first communication.

7. The evaluation system according to claim 1,
wherein a plurality of pieces of business information is registered in the database together with a disclosure information indicating a disclosure range to an applicant,
wherein the evaluation system further comprises an applicant apparatus operated by an applicant belonging to the second group, and
wherein the computing apparatus is configured to determine, based on the disclosure information, business information allowed to be disclosed to the applicant belonging to the second group among the plurality of pieces of business information registered in the database, and to provide the determined business information to the applicant belonging to the second group to the applicant apparatus.

8. A method for evaluating a vendor who has applied for a business,
with an evaluation system comprising:
a first evaluator apparatus that is operated by one or more evaluators belonging to a first group;
a computing apparatus that is configured to communicate with the first evaluator apparatus and to access to a database; and
a second evaluator apparatus that is operated by one or more evaluators belonging to a second group different from the first group,
the method comprising:
receiving, by the first evaluator apparatus, an input of a first evaluation for a vendor;
transmitting, by the first evaluator apparatus, the first evaluation to the computing apparatus;
receiving, by the second evaluator apparatus, an input of a second evaluation for the vendor;
transmitting, by the second evaluator apparatus, the second evaluation to the computing apparatus;
registering, by the computing apparatus, a first evaluation information based on the first evaluation received from the first evaluator apparatus in the database for each vendor;
registering, by the computing apparatus, a second evaluation information based on the second evaluation received from the second evaluator apparatus in the database for each vendor;
wherein when a browsing request is received by the computing apparatus from a transmission source in a first communication established by identification information that identifies a person belonging to the first group, transmitting, by the computing apparatus, the first evaluation information on the vendor to the transmission source of the first communication, and not transmitting the second evaluation information on the first vendor to the transmission source of the first communication; and
wherein when a browsing request is received by the computing apparatus from a transmission source in a second communication established by identification information that identifies a person belonging to the second group, transmitting, by the computing apparatus, the second evaluation information on the vendor to the transmission source of the second communication, and not transmitting the first evaluation information on the vendor to the transmission source of the second communication.
